(19) United States
(12) Patent Application Publication
(10) Pub. No.: US 2019/0208231 A1
(43) Pub. Date: Jul. 4, 2019

(54) INFORMATION PROCESSING APPARATUS, VIDEO DELIVERY APPARATUS AND CONTROL METHOD THEREOF

(71) Applicant: CANON KABUSHIKI KAISHA, Tokyo (JP)

(72) Inventors: Yuma Kitasei, Tokyo (JP); Koji Kawashima, Tokyo (JP); Takahiro Yamazaki, Yokohama-shi (JP)

(21) Appl. No.: 16/234,197

(22) Filed: Dec. 27, 2018

(30) Foreign Application Priority Data
Dec. 28, 2017 (JP) 2017-254395

(51) Int. Cl. H04N 21/218; H04L 29/08; H04L 29/06; H04N 21/214; H04N 21/437

(52) U.S. Cl. CPC H04N 21/21805; H04L 67/104; H04N 21/437; H04N 21/2143; H04L 65/60

(57) ABSTRACT

An information processing apparatus which generates free viewpoint video, in which a virtual viewpoint can be changed, using video data shot from a plurality of directions. The apparatus receives, from a video delivery apparatus, video data for generating the free viewpoint video at a predetermined viewpoint, generates the free viewpoint video at the predetermined viewpoint from the video data received from the video delivery apparatus, and carries out control so that when another information processing apparatus, which generates the free viewpoint video at a viewpoint included in a predetermined range from the predetermined viewpoint, is present, communication is carried out with the other information processing apparatus, and the free viewpoint video at the predetermined viewpoint is generated using video data received from the other information processing apparatus.

### BACKGROUND OF THE INVENTION

### Field of the Invention

This invention relates to an information processing apparatus, a video delivery apparatus and a control method thereof, particularly relates to a free viewpoint video generation system.

### Description of the Related Art

Video delivery over networks is currently based on simple client-server models. On-demand systems, in which many clients on a network issue requests to a server and video is delivered in response to those requests, are commonly used. When delivering content with large files sizes such as video in a client-server model, there is a problem that if the number of clients rises and there is a corresponding concentration of requests, a greater processing load will be placed on the server and lines near the server will become congested.

A data delivery method using Peer-to-peer (P2P) communication is known as one delivery method that addresses this server load problem. In P2P communication, terminals on a network that have an equivalent relationship connect to each other, which makes it possible to transmit and receive data, and thus deliver content, without using a server.

With respect to P2P network services for delivering live video and the like, Japanese Patent Laid-open No. 2013-258657 discloses a terminal and program used in a mesh-type P2P network service. Techniques for using video data shot by multiple cameras to generate video seen from a desired viewpoint are also known, as exemplified by Japanese Patent Laid-open No. 2010-121945.

Free viewpoint video generation systems, which use video data shot by multiple cameras to generate video seen from a desired viewpoint, are also known as technology for generating video data. By using multiple cameras installed in, for example, a soccer stadium or the like, the system can generate 3-D space data by calculating the three-dimensional positions of players, the ball, and so on. A server then delivers the data required to generate the video from a desired viewpoint to a user terminal, and the user terminal then generates free viewpoint video. This enables users to view the game at the stadium from a variety of different viewpoints.

A prerequisite of Japanese Patent Laid-open No. 2013-258657 is that the upstream-side terminals in the data communication hold the data required by the downstream-side terminals. However, in the above-described free viewpoint video generation system, video from different viewpoints and angles is required for each user terminal. If data which differs for each user, as is the case with such free viewpoint video, is delivered using the technique described in Japanese Patent Laid-open No. 2013-258657, there are situations where the upstream-side terminal does not have the data required to generate a user's desired video.

### SUMMARY OF THE INVENTION

The present invention has been made in consideration of the aforementioned problems, and realizes a system capable of reducing the processing load involved in delivering video to individual terminals.

In order to solve the aforementioned problems, the present invention provides an information processing apparatus which generates free viewpoint video, in which a virtual viewpoint can be changed, using video data shot from a plurality of directions, the apparatus comprising: a communication unit configured to receive, from a video delivery apparatus, video data for generating the free viewpoint video at a predetermined viewpoint; a generation unit configured to generate the free viewpoint video at the predetermined viewpoint from the video data received from the video delivery apparatus; a display unit configured to display the free viewpoint video; and a control unit configured to carry out control so that when another information processing apparatus, which generates the free viewpoint video at a viewpoint included in a predetermined range from the predetermined viewpoint, is present, communication is carried out with the other information processing apparatus, and the free viewpoint video at the predetermined viewpoint is generated using video data received from the other information processing apparatus.

In order to solve the aforementioned problems, the present invention provides a video delivery apparatus which has video data shot from a plurality of directions, and transmits video data for generating free viewpoint video, in which a virtual viewpoint can be changed, to a first information processing apparatus, the video delivery apparatus comprising: a communication unit configured to transmit, to the first information processing apparatus, video data for generating free viewpoint video at a predetermined viewpoint, on the basis of viewpoint information received from the first information processing apparatus; a determination unit configured to determine, on the basis of the viewpoint information, whether a second information processing apparatus that generates free viewpoint video at a viewpoint included in a predetermined range from the predetermined viewpoint is present; and a control unit configured to carry out control so that when the second information processing apparatus is present, the first information processing apparatus communicates with the second information processing apparatus without traversing the video delivery apparatus, and device information for receiving the video data for generating the free viewpoint video at the predetermined viewpoint is transmitted to the first information processing apparatus.

In order to solve the aforementioned problems, the present invention provides a method of controlling an information processing apparatus, the information processing apparatus including a generation unit configured to generate free viewpoint video, in which a virtual viewpoint can be changed, using video data shot from a plurality of directions, and a communication unit configured to receive, from a video delivery apparatus, video data for generating free viewpoint video at a predetermined viewpoint, the method comprising: carrying out control so that when another information processing apparatus, which generates the free viewpoint video at a viewpoint included in a predetermined range from the predetermined viewpoint, is present, communication is carried out with the other information processing apparatus, and the free viewpoint video at the predetermined viewpoint is generated using video data received from the other information processing apparatus.

In order to solve the aforementioned problems, the present invention provides a method of controlling a video delivery apparatus, the video delivery apparatus having video data shot from a plurality of directions and transmitting video data for generating free viewpoint video, in which a virtual viewpoint can be changed, to a first information processing apparatus, the method comprising: determining, on the basis of viewpoint information received from e first information processing apparatus, whether a second information processing apparatus that generates free viewpoint video at a viewpoint included in a predetermined range from the predetermined viewpoint is present; and carrying out control so that when the second information processing apparatus is present, the first information processing apparatus communicates with the second information processing apparatus without traversing the video delivery apparatus, and device information for receiving the video data for generating the viewpoint video at the predetermined viewpoint is transmitted to the first information processing apparatus.

According to the present invention, the processing load involved in delivering video to individual terminals can be reduced.

Further features of the present invention will become apparent from the following description of exemplary embodiments (with reference to the attached drawings).

### BRIEF DESCRIPTION OF THE DRAWINGS

FIG. 1 is a block diagram illustrating the configurations of a user terminal and a server in a system according to a present embodiment.

FIG. 2 is a diagram illustrating a system configuration according to the present embodiment.

FIG. 3 is a diagram illustrating an example of a data table managed by a server according to a first embodiment.

FIG. 4 is a diagram illustrating a method of calculating video data necessary for generating free viewpoint video according to the first embodiment.

FIG. 5 is a sequence chart for the user terminal and the server according to the first embodiment.

FIG. 6 is a flowchart illustrating operations performed by the user terminal according to the first embodiment.

FIG. 7 is a flowchart illustrating operations performed by the server according to the first embodiment.

FIG. 8 is a diagram illustrating a data table managed by the server according to a second embodiment.

FIG. 9 is a sequence chart for the user terminal and the server according to the second embodiment.

FIG. 10 is a flowchart illustrating operations performed by the user terminal according to the second embodiment.

FIG. 11 is a flowchart illustrating operations performed by the server according to the second embodiment.

FIG. 12 is a diagram illustrating a network correspondence relationship.

FIG. 13 is a diagram illustrating a data table managed by the server according to a third embodiment.

FIG. 14 is a diagram illustrating a data table managed by the server according to a fourth embodiment.

FIG. 15 is a sequence chart for the user terminal and the server according to the fourth embodiment.

FIG. 16 is a flowchart illustrating operations performed by the user terminal according to the fourth embodiment.

FIG. 17 is a flowchart illustrating operations performed by the user terminal according to the fourth embodiment.

FIG. 18 is a diagram illustrating a move destination table managed by the server according to a fifth embodiment.

FIGS. 19A and 19B are sequence charts for the user terminal and the server according to the fifth embodiment.

FIGS. 20A and 20B are flowcharts illustrating operations performed by the user terminal according to the fifth embodiment.

FIG. 21A is a flowchart illustrating the process of S2002 in FIG. 20A.

FIG. 21B is a flowchart illustrating the process of S2004 in FIG. 20A.

FIG. 22 is a diagram illustrating an example of a GUI according to the fifth embodiment.

FIG. 23 is a flowchart illustrating the process of S2006 in FIG. 20A.

FIG. 24 is a flowchart illustrating operations performed by the server according to the fifth embodiment.

FIG. 25 is a diagram illustrating an example of the GUI according to a sixth embodiment.

### DESCRIPTION OF THE EMBODIMENTS

Embodiments of the present invention will be described in detail below The following embodiments are merely examples for practicing the present invention. The embodiments should be properly modified or changed depending on various conditions and the structure of an apparatus to which the present invention is applied. The present invention should not be limited to the following embodiments. Also, parts of the embodiments to be described later may be properly combined.

The present embodiment will describe a system in which a server, a user terminal, and a plurality of cameras installed in a stadium for sports, concerts, or the like so as to surround the field, stage, or the like, are connected over a network, and free viewpoint video is generated in the user terminal using video data shot by the plurality of cameras.

In the free viewpoint video generation system, by controlling multiple cameras over the network to shoot at the same timing, the server generates high-resolution 3-D space data from video shot from multiple directions. The user terminal generates free viewpoint video in which a virtual camera can be moved freely in a 3-D space, which makes it possible to view the video from a variety of viewpoints and angles.

In the present embodiment, “camera” refers to an image capture apparatus such as a digital camera capable of shooting high-resolution video. “Server” refers to a video delivery apparatus such as a client server which delivers video data shot by the plurality of cameras to the user terminal, for example. “User terminal” refers to an information processing apparatus such as a smartphone, which is one type of mobile phone, a laptop, tablet, a wearable personal computer (PC), or the like.

The server saves the video data shot by the plurality of cameras and delivers the video data in accordance with the viewpoint of each user terminal. Each user terminal generates the free viewpoint video from the video data received from the server and displays the video so as to be viewable by the user.

“Free viewpoint video” is video in which the user can freely change the viewpoint, and is obtained by carrying out image processing on each frame image of video data shot by a plurality of cameras. Although the method for generating free viewpoint video is not particularly limited in the present embodiment, several methods for generating free viewpoint video exist. Japanese Patent Laid-open No. 2010-121945 discloses a volume intersection method that generates free viewpoint video by generating a three-dimensional model of an object using video data shot by a plurality of cameras, applying a texture to the three-dimensional model, and changing the display angle and display distance.

In the free viewpoint video generation system according to the present embodiment, when a given user is viewing video from a viewpoint near the viewpoint of video being viewed by another user, at the same time as that other user, it is thought that the given user's terminal has video data resembling the video data required to generate the free viewpoint video.

Thus in the present embodiment, when a given user terminal is generating and displaying video from a viewpoint close to the viewpoint of video being displayed in another user terminal (a viewpoint included in a predetermined range from a predetermined viewpoint), and that given user terminal holds video data required to generate free viewpoint video, the video data is acquired directly, without using a server, through communication between the user terminals. This makes it possible to reduce the processing load involved with the server delivering video.

The following will describe the closeness of viewpoints of user terminals in the free viewpoint video generation system according to the present embodiment.

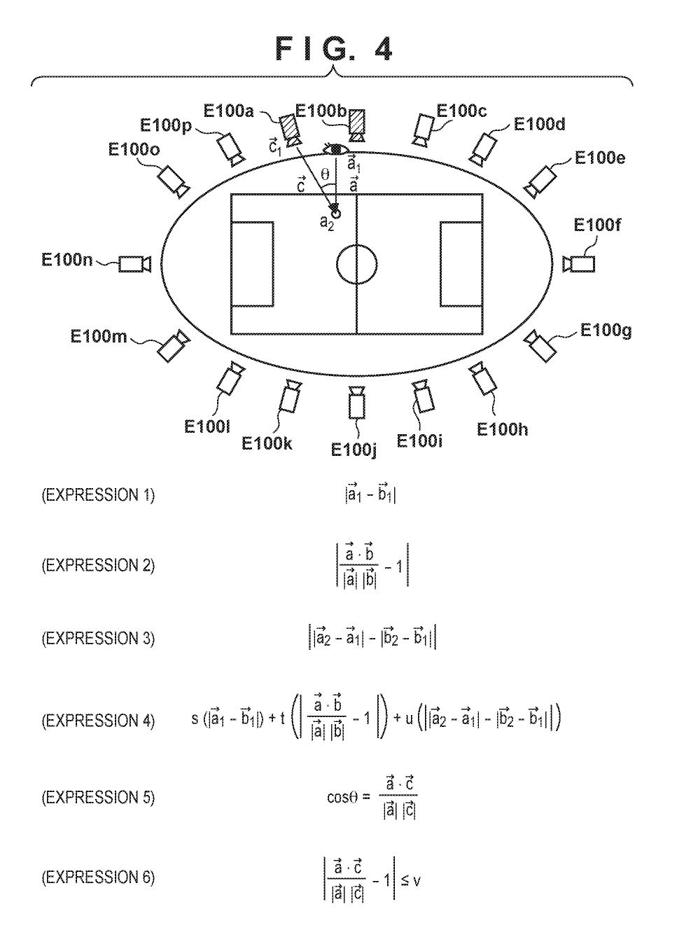

In the present embodiment, the closeness of viewpoints is defined as follows using Expressions 1 to 4 in FIG. 4.

Using a viewpoint vector a(\vec{a}), a viewpoint position vector a₁(\vec{a}₁), and a gaze position vector a₂(\vec{a}₂) of a user A₁, vector a₁=vector a₂−vector a₁(\vec{a}=\vec{a}₂−\vec{a}₁). Likewise, using a viewpoint vector b(\vec{b}), a viewpoint position vector b₁(\vec{b}₁), and a gaze position vector b₂(\vec{b}₂) of a user B, vector b=vector b₂−vector b₁(\vec{b}=\vec{b}₂−\vec{b}₁). Here, “viewpoint position” refers to a virtual camera position in the free viewpoint video, whereas “gaze position” refers to the position of an object the user is looking at (an object in front of the user's line of sight).

The closeness of the viewpoints of user A and user B depends on three factors, namely the viewpoint positions, viewpoint directions, and distance to the gaze position from the viewpoint. The viewpoints of the user A and the user B are assumed to be closer the lower the differences among these factors are. The difference between the viewpoint positions of the user A and user B is expressed by Expression 1. A difference in angles between the user A and user B is proportional to the value of Expression 2. The difference between distances from the viewpoints to the gaze positions of the user A and user B is expressed by Expression 3.

When weights on the viewpoint position, viewpoint direction, and distance from the viewpoint to the gaze position, which are used to evaluate the closeness of the viewpoints, are represented by s (s>0), t (t>0), and u (u>0), respectively, an evaluation value indicating the viewpoint closeness is expressed by Expression 4. The viewpoints of the user A and the user B are said to be closer the closer the evaluation value indicated by Expression 4 is to 0.

Note that the above-described definitions and evaluation method pertaining to viewpoint closeness are merely examples, and the definitions, evaluation method, and expressions are not limited to those described above.

Device Configuration

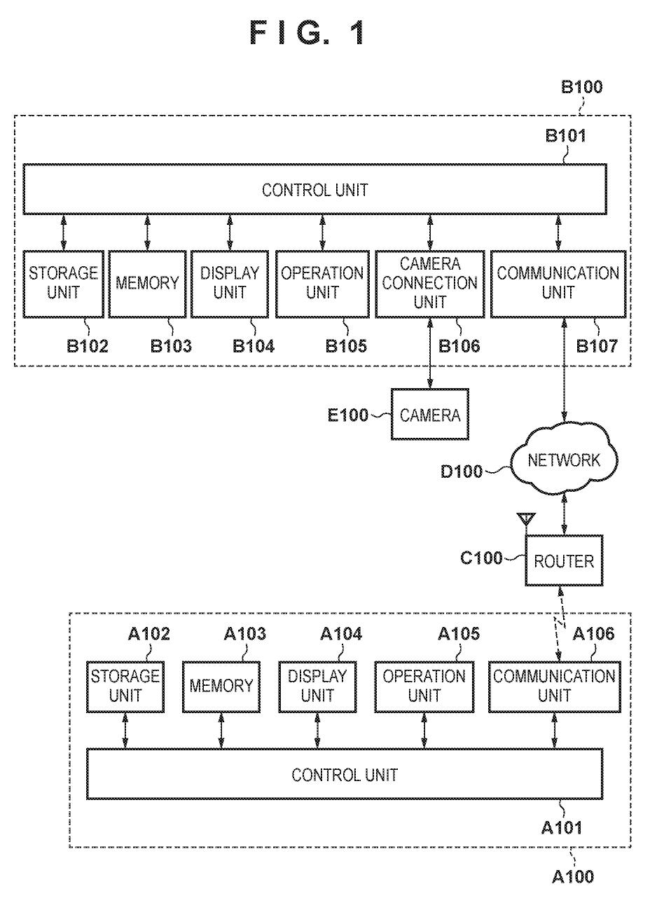

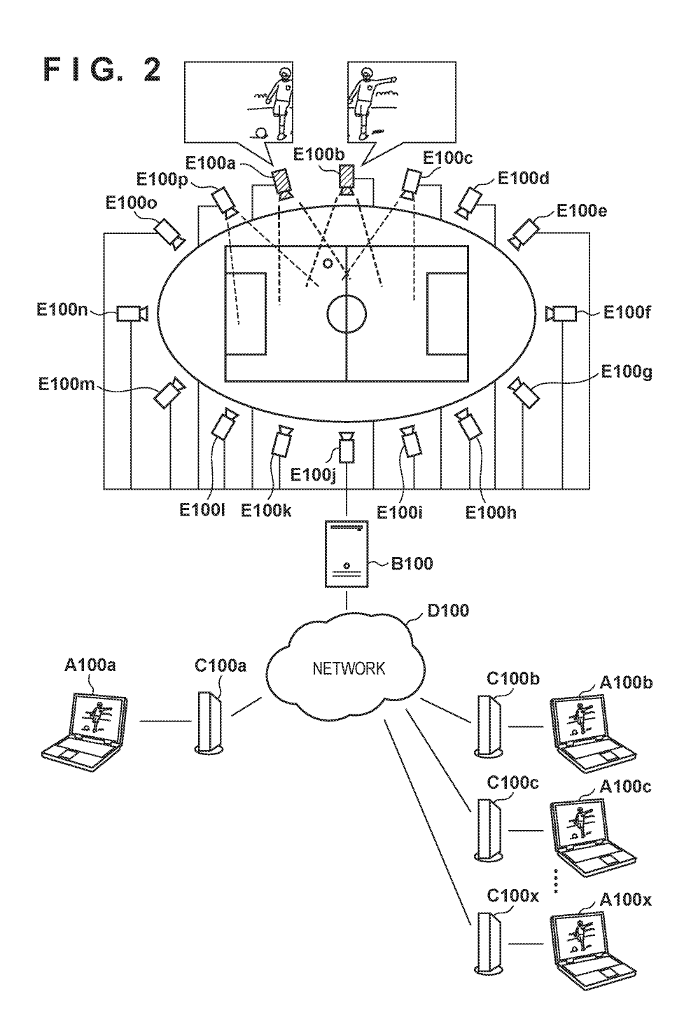

The configurations and functions of the user terminal and the server according to the present embodiment will be described next with reference to FIGS. 1 and 2.

A user terminal A100 includes a control unit A101, a storage unit A102, memory A103, a display unit A104, an operation unit A105, and a communication unit A106.

The control unit A101 is an arithmetic processing unit (CPU) that comprehensively controls the user terminal A100 as a whole, and realizes a communication process and a control process (described later) by executing programs stored in the storage unit A102 (described later). Note that a plurality of pieces of hardware may control the overall device by sharing processes instead of making the control unit A101 control the overall device. The same applies to the hardware of the server, which will be described below, which may be configured such that a plurality of pieces of hardware share processes.

The storage unit A102 is electrically erasable/recordable non-volatile memory, and may employ a hard disk drive (HDD), a solid-state drive (SSD), or the like, for example. Constants, programs, and the like for the operation of the control unit A101 are recorded in the storage unit A102. Here, “programs” refers to programs for executing the sequences according to the present embodiments, which will be described later.

The memory A103 is used as a work area where constants and variables for the operation of the control unit A101, programs read out from the storage unit A102, and the like are loaded. The memory A103 is also used as buffer memory for temporarily holding video data received from a server B100 (described later) or other user terminals, image display memory for the display unit A104, and so on. The volatile memory A103 is also used as an area for saving parameters and the like pertaining to communication connection settings made by the communication unit A106.

The display unit A104 displays free viewpoint video as well as a graphical user interface (GUI) containing text, graphics, symbols, and the like for performing interactive operations. The display unit A104 is a display device such as a liquid crystal display or an organic EL display, for example. The display unit A104 may be built into the user terminal A100, or may be an external device connected to the user terminal A100. It is sufficient for the user terminal A100 to be capable of connecting to the display unit A104 and having a function for controlling the display in the display unit A104.

The operation unit A105 is constituted by operation members such as various types of switches, buttons, a keyboard, a mouse, and so on which accept various types of operations from the user. A touch panel that is integrated with the display panel of the display unit A104 is also included in the operation unit A105.

The communication unit A106 is an interface for connecting to an external device such as the server B100 (described later), other user terminals, and so on. The user terminal A100 of the present embodiment can exchange data with an external device through the communication unit A106. In the present embodiment, the communication unit A106 communicates with the server B100 over a network D100, such as the Internet, to which connection is made through a router C100. A variety of communication methods, such as Ethernet (registered trademark), wireless LAN, or the like, can be employed as the communication method, if the user terminal A100 is a mobile phone, a smartphone, or the like, the communication unit A106 can use public wireless communication based on a standard such as W-CDMA (UMTS), Long-Term Evolution (LTE), or the like.

Note that applications for realizing practical functions in cooperation with an operating system (OS), which is the basic software of the user terminal, are installed in the user terminal A100. The various processes of the user terminal A100 in the system according to the present embodiment are realized by loading software provided by these applications. The applications are assumed to have software for using basic functions of the OS installed in the user terminal. Note that the OS of the user terminal may have software for realizing the processes according to the present embodiment. The applications in the present embodiment are assumed to be applications to carry out various types of processes for the free viewpoint video generation system.

The router C100 is a relay device that connects the user terminal A100 to the network D100 through the communication unit A106. The router C100 can also function as a wireless LAN access point, and thus the user terminal A100 can communicate wirelessly with the server B100 by connecting to the network D100 through the communication unit A106.

The server B100 includes a control unit B101, a storage unit B102, memory B103, a display unit B104, an operation unit B105, a camera connection unit B106, and a communication unit B107. Since the basic functions of these blocks are the same as those of the user terminal A100, detailed descriptions thereof will be omitted, and the following descriptions will focus primarily on the differences.

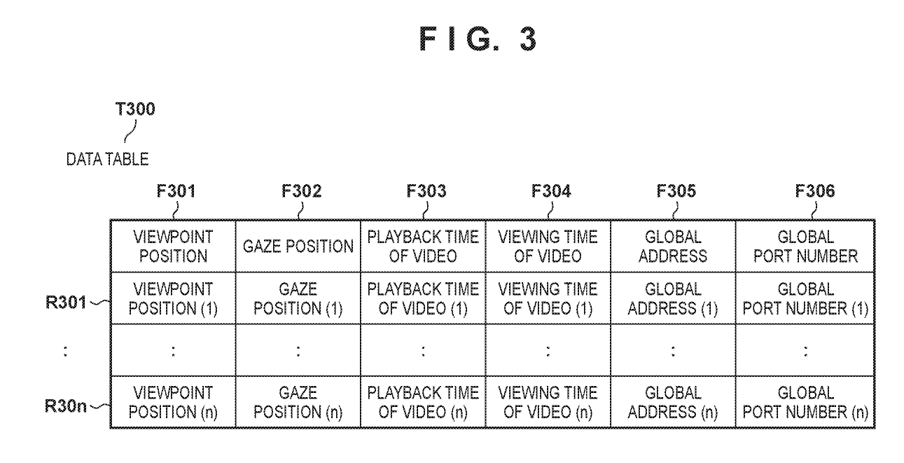

The storage unit B102 stores video data to be delivered to the user terminal A100 and a data table T300 (described later). The data table T300 will be described later with reference to FIG. 3.

The camera connection unit B106 includes an interface for connecting with a plurality of cameras E100 installed in a stadium. The control unit B101 controls the plurality of cameras E100 connected via the camera connection unit B106, acquires the video data shot by the cameras E100, and saves the video data in the storage unit 9102. The control unit B101 also generates high resolution 3-D space data from video data shot by the plurality of cameras E100 at the same timing but from different directions. Note that it is not necessary for the server B100 to always acquire the video data shot by the plurality of cameras E100 through the camera connection unit B106, and the video data may instead be acquired through the communication unit B107. It is sufficient for the server B100 to hold the video data to be delivered to the user terminal A100 in the storage unit B102.

A system configuration according to the present embodiment will be described next with reference to FIG. 2.

As illustrated in FIG. 2, the system according to the present embodiment includes a user terminal A100a, a user terminal A100b, a user terminal A100c, and so on up to a user terminal A100x, as well as the server B100. The user terminal A100a, the user terminal A100b, the user terminal A100c, and so on up to the user terminal A100x are assumed to have the same configurations and functions as the user terminal A100 illustrated in FIG. 1.

The user terminal A100a, the user terminal A100b, the user terminal A100c, and so on up to the user terminal A100x are the terminals of users viewing the free viewpoint video in the system according to the present embodiment, and the same number of user terminals A100 as there are users are present. Each user terminal A100 is connected to the network D100 via the router C100. The server B100 is made public over the network D100, and is therefore accessible by each user terminal A100. Note that it is not absolutely necessary for each user terminal A100 to be connected to the network D100 via the router C100, and the user terminal A100 may instead be connected to the network D100 directly.

The server B100 is connected to a plurality of cameras E100a to E100p, and can acquire video data shot by the cameras E100a to E100p. The number of the cameras E100a to E100p depends on the number of cameras installed in the stadium, and differs from stadium to stadium.

The data table T300 stored in the storage unit B102 of the server B100 in the system according to the present embodiment will be described next with reference to FIG. 3.

Viewpoint information and terminal information, which make it possible to manage the time and viewpoint at which each user terminal has viewed video, are registered in the data table T300. The viewpoint information includes the virtual viewpoint position and gaze position in the stadium at which the user is viewing the video, a playback time of the video, and a viewing time of the video. The terminal information also includes device information such as a global address and a global port number, which serve as information necessary for connecting user terminals to each other.

The data table T300 manages data in units of records that consolidate data as indicated by R301 and so on up to R30n.

The viewpoint position managed by a field F301 in the data table T300 is a position corresponding to a vector a₁(\vec{a}₁) when the viewpoint vector a(\vec{a}) of the user A is expressed as vector a=vector a₂−vector a₁(\vec{a}=\vec{a}₂−\vec{a}₁), and is a position of a virtual camera in the free viewpoint video.

The gaze position managed by a field F302 in the data table T300 is a position corresponding to a vector a₂(\vec{a}₂) when the viewpoint vector a(\vec{a}) of the user A is expressed as vector a=vector a₂−vector a₁(\vec{a}=\vec{a}₂−\vec{a}₁), and is a position in the free viewpoint video being viewed by the user A.

The playback time of the video, managed by a field F303 in the data table T300, is a time code of the video being viewed through the user terminal. The playback time of the video is used when the server B100 refers to the data table T300 to search for another user terminal that is viewing the video from a nearby viewpoint within the predetermined range from the viewpoint of the user terminal, in order to further narrow down the search for user terminals having similar playback times.

The viewing time of the video, which is managed by a field F304 in the data table T300, is the point in time when the user terminal started viewing the video. If there is a difference between the viewing time of the video and the time when the search was executed, it is less likely that the video data is cached in the user terminal and therefore less likely that the user terminal holds the video data. Accordingly, the viewing time of the video is used when the server B100 refers to the data table T300 to search for another user terminal that is viewing the video from a nearby viewpoint within the predetermined range from the viewpoint of the user terminal, in order to further narrow down the search for user terminals that are likely to have cached the video data.

The global address, which is managed by a field F305 in the data table T300, is the global address of the user terminal. The address is used when the user terminal connects to another user terminal.

The global port number, which is managed by a field F306 in the data table T300, is the global port number of the user terminal. The number is used when the user terminal connects to another user terminal.

The viewpoint information of the user terminal is updated when the viewpoint of the video the user wishes to view is changed, when a set amount of time has passed following the generation of the viewpoint information, and so on. Additional registrations are made in the data table T300, in units of records, when the viewpoint information of the user terminal A100 is updated and the viewpoint information is transmitted from the user terminal A100 to the server B100.

Registered records are deleted from the data table T300 once a set period has passed following the registration of those records. This is because the combination of the global address and the global port number assigned to a user terminal changes after several minutes when no communication is taking place, and the information in a record therefore becomes invalid once several minutes have passed following the registration.

A method of calculating the video data required to generate the free viewpoint video from a user's viewpoint information will be described next with reference to FIG. 4.

Using a viewpoint position vector a₁(\vec{a}₁) and a gaze position vector a₂(\vec{a}₂), the viewpoint of the user A is expressed as vector a=vector a₂−vector a₁(\vec{a}=\vec{a}₂−\vec{a}₁). When the position of a camera installed in the stadium is represented by a vector c₁(\vec{c}₁), the distance from the camera to the gaze position of the user A is expressed as vector c=vector a₁−c₁(\vec{c}=\vec{a}₁−\vec{c}₁). The user A generates the free viewpoint video using the video data from a camera in a position in which the angle formed by the vector a(\vec{a}) and the vector c(\vec{c}) is less than or equal to a set value.

At this time, when the angle formed by the vector a(\vec{a}) and the vector c(\vec{c}) is represented by θ (where vector a(\vec{a})≠vector 0(\vec{0}), vector c(\vec{c})≠vector 0(\vec{0}), and 0≤θ≤180°), cos θ is expressed by Expression 5. cos θ=1 when θ=0°, and thus the closer the value of Expression 5 is to 1, the closer the angle θ formed by the vector a(\vec{a}) and the vector c(\vec{c}) is to 0°. Thus if a threshold v is set so that the angle θ formed by the vector a(\vec{a}) and the vector c(\vec{c}) is less than or equal to a set value, v can be expressed by Expression 6.

Accordingly, the video data required by the terminal of the user A to generate the free viewpoint video is the video data of the camera installed at the position satisfying Expression 6. Note that this method is merely an example, and other methods, expressions, and so on may be used instead.

A method through which video data IDs common for the user terminal A100 and the server B100 are generated will be described next.

The video data is obtained by dividing video shot by a plurality of cameras by set intervals, and video data IDs for uniquely identifying the video data are assigned to all of the pieces of video data. The method for assigning the video data. IDs is the same for the user terminals A100 and the server B100, and the same video data has the same video data ID for the user terminals A100 and the server B100.

The video data ID is a value unique to each piece of video data, and is determined in accordance with the camera that shot the video data and the date/time at which the video was shot. Accordingly, the camera that shot the video data and the date/time at which the video was shot can be used to find the video data ID of the corresponding video data. For example, assume that the method for generating the video data ID uses “camera name_shooting time”. Assuming that the video data is obtained by dividing the video shot by each camera into five-second intervals, the video data ID of the five seconds' worth of video data shot by the camera E100a starting at 4:56:00 on Jan. 23, 2017, is, based on the camera that shot the video and the shooting date/time, “E100a_201712345600”. If the user terminal A100 requires the five seconds' worth of video data shot by the camera E100a starting at 4:56:00 on Jan. 23, 2017, the user terminal A100 can acquire the video data by transmitting a video data request to the server B100 or another user terminal A100 using the video data ID of “E100a_201712345600”. Although five seconds is given as the length of the video data here, the video data may have any length. However, it is necessary for the length of each piece of video data to be the same throughout the system including the user terminals A100 and the server B100. The method for generating the video data ID may also be different, as long as the same method is used throughout the system including the user terminals A100 and the server B100.

Operations

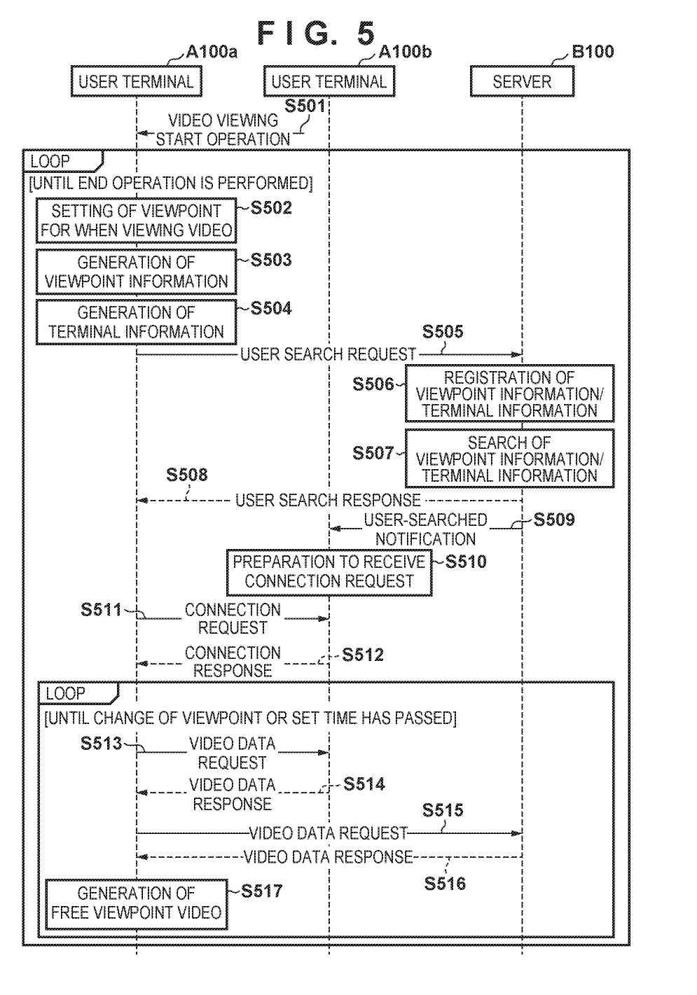

Operations performed by the user terminal A100 and the server B100 according to the present embodiment will be described next with reference to FIGS. 5 to 7.

Note that the following describes an example in which the user terminal A100a generates the free viewpoint video and thus receives part of the video data required to generate the free viewpoint video from the user terminal A100b, which has similar viewpoint information. The remaining video data that could not be acquired from the user terminal A100b is received from the server B100.

FIG. 5 illustrates an example of a sequence of the operations carried out by the user terminal A100 and the server B100 according to the present embodiment.

It is assumed that at starting point of the sequence in FIG. 5, the user terminal A100a holds the global address and the global port number temporarily assigned to the user terminal A100a in the memory A103. The user terminal A100a acquires the global address and the global port number using Session Traversal Utilities for NATs (STUN) or the like.

Likewise, it is assumed that the user terminal A100b holds the global address and the global port number temporarily assigned to the user terminal A100b in the memory A103. The user terminal A100b also acquires the global address and the global port number using Session Traversal Utilities for NATs (STUN) or the like.

It is furthermore assumed that the user terminal A100a has already acquired location information of each of the cameras E100 from the server B100, and has saved that location information in the memory A103. The user terminal A100a can generate all of the video data IDs required to generate the free viewpoint video from the viewpoint information and the location information already acquired for each of the cameras E100.

The sequence of FIG. 5 starts when in S501, the user terminal A100a accepts a video viewing start operation from the user, through the operation unit A105 of the user terminal A100a.

In S502, the user terminal A100a accepts a viewpoint operation from the user through the operation unit A105 of the user terminal A100a, and sets the viewpoint position and gaze position for when the video is viewed as well as the playback time of the video.

In S503, the user terminal A100a generates the viewpoint information from the viewpoint position, the gaze position, and the playback time of the video determined in S502, as well as the current time. The current time is set as the viewing time of the video.

In S504, the user terminal A100a generates the terminal information.

In S505, the user terminal A100a transmits a user search request to the server B100.

In S506, the server B100 saves, in the data table T300 of the storage unit B102, the viewpoint information and the terminal information, which are included in the user search request received from the user terminal A100a in S505.

In S507, on the basis of the viewpoint information included in the user search request received from the user terminal A100a in S505, the server B100 searches the data table T300 in the storage unit B102 and acquires the terminal information of another user terminal, which has a viewpoint position and a playback time that are close and in which video data is highly likely to be remaining. It is assumed here that video is being viewed in the user terminal A100b earlier than the user terminal A100a, and that the viewpoint information and the terminal information of the user terminal A100b are registered in the data table T300.

In S508, the server B100 transmits the terminal information of the zero, or one or more, other user terminals acquired in S507 to the user terminal A100a as a user search response.

If the terminal information of one or more other user terminals has been transmitted to the user terminal A100a in S508, in S509, the server B100 transmits the terminal information of the user terminal A100a to one or more other user terminals as a user-searched notification.

The following descriptions will assume that the terminal information acquired in S507 is the terminal information of the user terminal A100b.

In S510, the user terminal A100b prepares to receive the connection request transmitted from the user terminal A100a, on the basis of the terminal information of the user terminal A100a included in the user-searched notification received from the server B100 in S509. For example, hole punching or the like is carried out with the global address and the global port number denoted in the terminal information of the user terminal A100a in order to carry out P2P communication with the user terminal A100a. The connection request will be described later with reference to S511.

In S511, the user terminal A100a transmits the connection request to the user terminal A100b on the basis of the terminal information of the user terminal A100b received from the server B100 in S508.

In S512, the user terminal A100b transmits a connection response in response to the connection request received from the user terminal A100a in S511.

In S513, the user terminal A100a transmits a video data request to the user terminal A100b in order to request the video data required to generate the free viewpoint video. The video data request includes the video data ID of the video data required to generate the free viewpoint video, which has been calculated using the viewpoint information as well as the already-acquired location information of the cameras E100.

In S514, if the user terminal A100b has the video data requested by the user terminal A100a in S513, the user terminal A100b transmits the video data to the user terminal A100a as a video data response. If the user terminal A100b does not have even one piece of the requested video data, the user terminal A100b transmits an indication that the user terminal A100b does not have the video data to the user terminal A100a as the video data response.

If in S514, the user terminal A100a has received all the requested video data, the process moves to S517. If in S514, the user terminal A100a has not successfully received all the video data, the process moves to S515.

In S515, the user terminal A100a transmits a video data request to the server B100 if all the video data required to generate the free viewpoint video has not been successfully received. The video data request includes the video data ID of the video data, among the video data required to generate the free viewpoint video, that could not be received in S514.

In S516, the server B100 transmits the video data requested by the user terminal A100a in S515 to the user terminal A100a.

In S517, the user terminal A100a generates the free viewpoint video using the video data received in S514 and/or S516.

Through the above-described sequence, the user terminal A100a can generate video from the viewpoint determined in S502. By the user terminal A100a generating and displaying the free viewpoint video by repeating S513 to S517, the user can view the free viewpoint video. Additionally, if the user has changed the viewpoint of the video he/she wishes to view or a set amount of time has passed after the viewpoint information was generated, the user terminal A100a can receive the video data from a user terminal having video data similar to the updated viewpoint information by carrying out the processing from S502.

In the present embodiment, the user terminal A100a generates the free viewpoint video using video data received from a single user terminal A100b. However, there are also situations where in S508, the server B100 transmits the terminal information of, for example, the user terminal A100b, the user terminal A100c, and the user terminal A100d as the user search response. In this case, the user terminal A100a generates the free viewpoint video by acquiring the video data from the user terminal A100b, the user terminal A100c, and the user terminal A100d.

Thus when a plurality of user terminals similar to the user terminal A100a are present, the number of terminals to connect to the user terminal A100a at the same time may be controlled in accordance with the communication environment of the user terminal A100b, the user terminal A100c, and the user terminal A100d, for example. For example, connecting fewer terminals improves the performance in communication environments having low data transfer speeds, and thus connecting more terminals in communication environments having high data transfer speeds increases the likelihood that a connected user terminal will have the required video data.

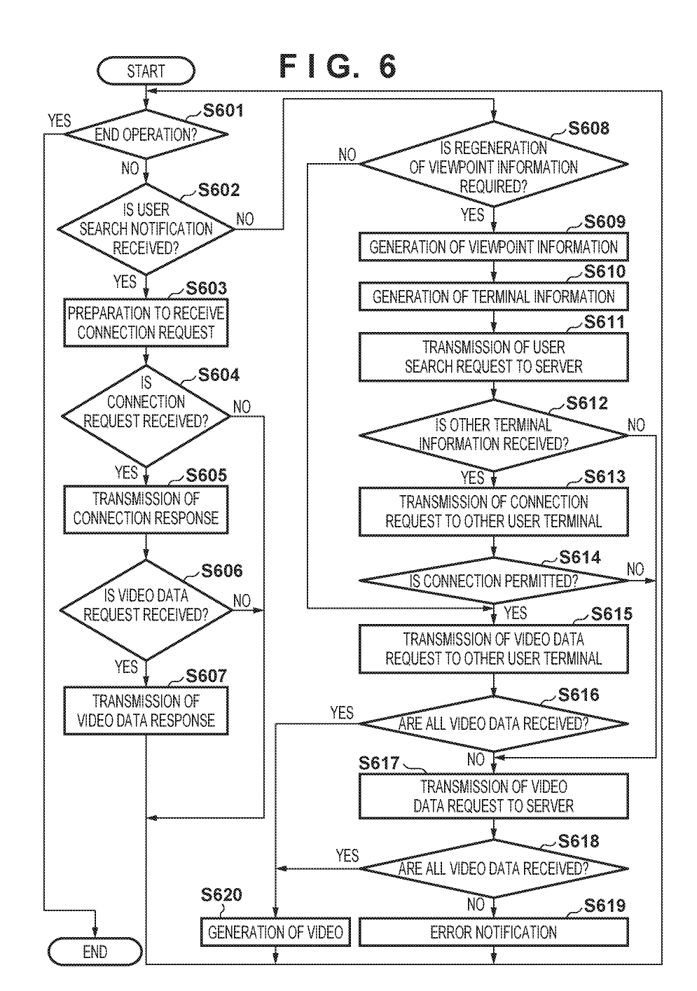

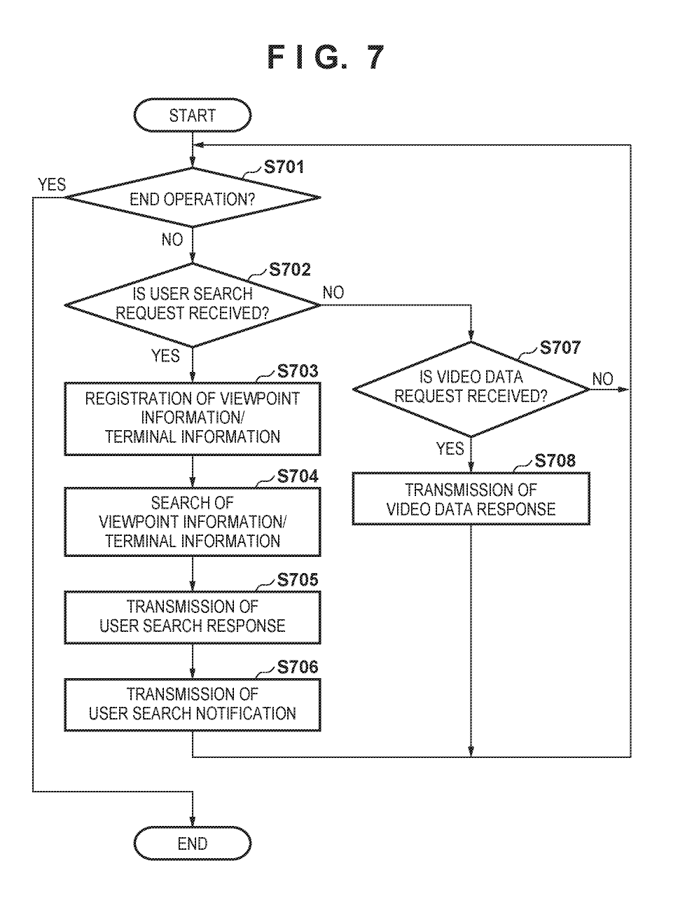

Operations performed by the user terminal A100 and the server B100 for realizing the sequence rated in FIG. 5 will be described next with reference to FIGS. 6 and 7.

Operations performed by the user terminal A100 will be described first with reference to FIG. 6.

Note that the processing illustrated in FIG. 6 is started when the user terminal A100 launches a dedicated application. The processing illustrated in FIG. 6 is realized by the control unit A101 of the user terminal A100 loading a control program read out from the storage unit A102 into the memory A103 and executing the program.

In S601, the control unit A101 determines whether or not to terminate the processing on the basis of the state of the user terminal A100. For example, the control unit A101 terminates the processing illustrated in the flowchart if an operation to end the application has been made through the operation unit A105. If the processing is to be continued, the control unit A101 moves the processing to S602.

In S602, the control unit A101 determines whether a user search notification has been received from the server B100 through the communication unit A106. The processing moves to S603 if the control unit A101 has determined that the user search notification has been received. However, the processing moves to S608 if the control unit A101 has determined that the user search notification has not been received.

In S603, the control unit A101 prepares to receive a connection request transmitted from another terminal. For example, hole punching or the like is carried out through the communication unit A106 in order to establish P2P communication with another user terminal. The process for transmitting the connection request will be described later with reference to S614. The process of this step corresponds to the processes of S509 and S510 in FIG. 5.

In S604, the control unit A101 determines whether a connection request has been received from another user terminal through the communication unit A106. The processing moves to S605 if the control unit A101 has determined that a connection request has been received. However, the processing moves to S601 if the control unit A101 has determined that a connection request has not been received.

In S605, the control unit A101 determines, on the basis of the state of the user terminal A100, whether to connect to the user terminal that transmitted the connection request received in S604. The control unit A101 transmits the result of this determination as a connection response to the other user terminal through the communication unit A106. The process of this step corresponds to the processes of S511 and S512 in FIG. 5.

In S606, the control unit A101 determines whether a video data request has been received from another user terminal through the communication unit A106. The processing moves to S607 if the control unit A101 has determined that a video data request has been received. However, the processing moves to S601 if the control unit A101 has determined that a video data request has not been received.

In S607, if the video data requested by the video data request received in S606 is present, the control unit A101 transmits the video data to the other user terminal through the communication unit A106 as a video data response. If the video data requested by the video data request is not present, the control unit A101 transmits an indication that the video data is not present to the other user terminal through the communication unit A106 as the video data response. The process of this step corresponds to the processes of S513 and S514 in FIG. 5.

In S608, the control unit A101 determines whether it is necessary to regenerate the viewpoint information. It is determined to be necessary to regenerate the viewpoint information if, based on the state of the operation unit A105, a viewpoint change operation has been made or a set amount of time has passed following the generation of the viewpoint information. The control unit A101 moves the processing to S609 if it has been determined that it is necessary to regenerate the viewpoint information. However, the control unit A101 moves the processing to S615 if it has been determined that it is not necessary to regenerate the viewpoint information.

In S609, the control unit A101 generates the viewpoint information for the current time for viewing the video, on the basis of the states of the storage unit A102, the memory A103, and the operation unit A105. The control unit A101 holds the generated viewpoint information in the storage unit A102 and the memory A103. The process of this step corresponds to the processes of S502 and S503 in FIG. 5.

In S610, the control unit A101 generates the terminal information on the basis of the states of the storage unit A102 and the memory A103. The process of this step corresponds to the process of S504 in FIG. 5.

In S611, the control unit A101 transmits the user search request to the server B100 through the communication unit A106. The control unit A101 includes the viewpoint information generated in S609 and the terminal information generated in S610 in the user search request. The process of this step corresponds to the process of S505 in FIG. 5.

In S612, the control unit A101 determines whether other terminal information has been received as the user search response from the server B100 through the communication unit A106. The processing moves to S613 if the control unit A101 has determined that the other terminal information has been received. The processing moves to S617 if the control unit A101 has determined that the other terminal information has not been received.

In S613, the control unit A101 transmits the connection request to the other terminal through the communication unit A106, on the basis of the other terminal information received from the server B100 in S612. The process of this step corresponds to the process of S511 in FIG. 5.

In S614, the control unit A101 receives a connection response from the other user terminal through the communication unit A106 and determines whether connection permission has been obtained. The processing moves to S615 if the control unit A101 has determined that connection permission has been obtained. The processing moves to S617 if the control unit A101 has determined that connection permission has not been obtained. The process of this step corresponds to the process of S512 in FIG. 5.

In S615, the control unit A101 transmits the video data IDs of all the video data required to generate the free viewpoint video to the other user terminal through the communication unit A106, as a video data request. The process of this step corresponds to the process of S513 in FIG. 5.

In S616, the control unit A101 determines whether all of the video data requested in S615 has been received as a video response from the other user terminal through the communication unit A106. The processing moves to S620 if the control unit A101 has determined that all the video data has been received. The processing moves to S617 if the control unit A101 has determined that not all the video data has been received. The process of this step corresponds to the process of S514 in FIG. 5.

In S617, the control unit A101 transmits the video data ID of the video data, among the video data required to generate the free viewpoint video, that could not be received in S616, to the server B100 through the communication unit A106, as a video data request. If the processes of S615 and S616 have not yet been carried out, the control unit A101 transmits the video data IDs of all the video data required to generate the free viewpoint video to the server B100 through the communication unit A106, as the video data request. The process of this step corresponds to the process of S515 in FIG. 5.

In S618, the control unit A101 determines whether all of the video data requested in S617 has been received as a video response from the other user terminal through the communication unit A106. The processing moves to S620 if the control unit A101 has determined that all the video data has been received. The processing moves to S619 if the control unit A101 has determined that not all the video data has been received. The process of this step corresponds to the process of S516 in FIG. 5.

In S619, the control unit A101 communicates an error to the user of the user terminal A100, through the display unit A104.

In S620, the control unit A101 saves the video data received in S616 or S618 in the storage unit A102. The control unit A101 reads out the video data saved in the storage unit A102 to the memory A103, combines the video data, and generates the free viewpoint video. The process of this step corresponds to the process of S517 in FIG. 5.

Note that the processing illustrated in FIG. 7 is started when a dedicated application is launched in the server B100. Furthermore, the processing illustrated in FIG. 7 is realized by the control unit B101 of the server B100 loading a control program read out from the storage unit B102 into the memory B103 and executing the program.

In S701, the control unit B101 determines whether or not to terminate the processing on the basis of the state of the server B100. For example, the control unit B101 terminates the processing if an operation to end the application has been made through the operation unit B105. If the processing is to be continued, the control unit B101 moves the processing to S702.

In S702, the control unit B101 determines whether a user search request has been received from the user terminal A100 through the communication unit B107. The processing moves to S703 if the control unit B101 has determined that a user search request has been received. The processing moves to S707 if the control unit B101 has determined that a user search request has not been received. The process of this step corresponds to the process of S505 in FIG. 5.

In S703, the control unit B101 registers, in the data table T300, the viewpoint information and the terminal information included in the user search request received from the user terminal A100 in S702. The process of this step corresponds to the process of S506 in FIG. 5.

In S704, the control unit B101 searches out and acquires the terminal information of another user terminal having a similar viewpoint and playback time and in which video data is highly likely to remain, on the basis of the viewpoint information included in the user search request received from the user terminal A100 in S702. The process of this step corresponds to the process of S507 in FIG. 5.

In S705, the control unit B101 transmits, as a user search response, the one or more pieces of terminal information acquired in S704 to the user terminal A100 from which the user search request was transmitted, through the communication unit B107. The process of this step corresponds to the process of S508 in FIG. 5.

In S706, if the control unit B101 has transmitted the terminal information acquired in S704 to the user terminal A100 as a user search response, the control unit B101 transmits, as a user search notification, the terminal information included in the user search request received from the user terminal A100 in S702 to the user terminal A100 corresponding to the terminal information acquired in S704. The process of this step corresponds to the process of S509 in FIG. 5.

In S707, the control unit B1.01 determines whether a video data request has been received from the user terminal A100 through the communication unit B107. The processing moves to S708 if the control unit B101 has determined that a video data request has been received. However, the processing moves to S701 if the control unit B101 has determined that a video data request has not been received.

In S708, if the video data requested by the video data request received in S707 is present, the control unit B101 transmits, as a video data response, the video data to the user terminal A100 that transmitted the video data request. If the video data requested by the video data request is not present, the control unit B101 transmits an indication that the video data is not present as a video data response to the user terminal A100 that transmitted the video data request, through the communication unit B107. The process of this step corresponds to the processes of S515 and S516 in FIG. 5.

According to the present embodiment, the user terminal A100a transmits the viewpoint information to the server B100, and receives, from the server B100, the terminal information of the other user terminal A100b, which is similar to the viewpoint of the video to be viewed in the user terminal A100a. The video data can therefore be received directly from the other user terminal A100b rather than the server B100, and the processing load on the server B100 for delivering the video can be reduced. Furthermore, the free viewpoint video is generated by each user terminal A100, and thus the processing load on the server can be reduced compared to a system in which the free viewpoint video is generated by the server B100.

### Second Embodiment

A second embodiment will be described next.

In the first embodiment, the server B100 uses the viewpoint information of the user terminal A100 to transmit, as the user search response, the terminal information of another user terminal similar to the viewpoint of the video to be viewed. However, it is not necessarily the case that the other user terminal has the required video data.

Accordingly, in the present embodiment, the server B100 holds a data table that manages Which user has which video data, in order to search for the other user terminal having the video data required to generate the free viewpoint video. This makes it possible for the server B100 to transmit information of the user terminal that has the video data required to generate the free viewpoint video as the user search response. Which in turn increases the likelihood that a user terminal can acquire the video data from another user terminal.

The following descriptions will focus upon the differences from the first embodiment. Note that the configurations of the user terminal A100 and the server B100 according to the present embodiment are the same as those illustrated in FIG. 1. The system configuration according to the present embodiment is also the same as that illustrated in FIG. 2.

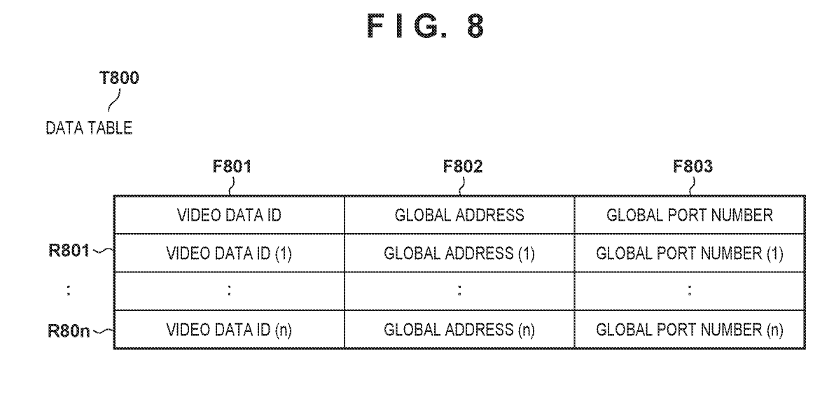

First, a data table T800 stored in the storage unit B102 of the server B100 according to the present embodiment will be described with reference to FIG. 8.

Video data information and terminal information are registered in the data table T800 so that which user terminal has which video data can be managed. The video data information includes a video data ID for uniquely identifying the video data. The terminal information includes a global address and a global port number as information necessary for connecting user terminals to each other, as in the first embodiment.

The data table T800 manages data in units of records that consolidate data as indicated by R801 and so on up to R80n.

The video data ID, which is managed by a field F801 in the data table T800, is unique information for uniquely identifying the video data delivered from the server B100.

The global address, which is managed by a field F802 in the data table T800, is the global address of the user terminal. The number is used when the user terminal connects to another user terminal.

The global port number, which is managed by a field F803 in the data table T800, is the global port number of the user terminal. The number is used when the user terminal connects to another user terminal.

The video data information of the user terminal A100 is updated when video data required to generate the free viewpoint video has changed in response to a change in the viewpoint of the video the user wishes to view, or when a set amount of time has passed following the generation of the video data information. Additional registrations are made in the data table T800, in units of records, when the video data information of the user terminal A100 is updated and the video data information is transmitted from the user terminal A100 to the server B100.

Registered records are deleted from the data table T800 once a set period has passed following the registration of those records. This is because the combination of the global address and the global port number assigned to a user terminal changes after several minutes when no communication is taking place, and the information in a record therefore becomes invalid once several minutes have passed following the registration.

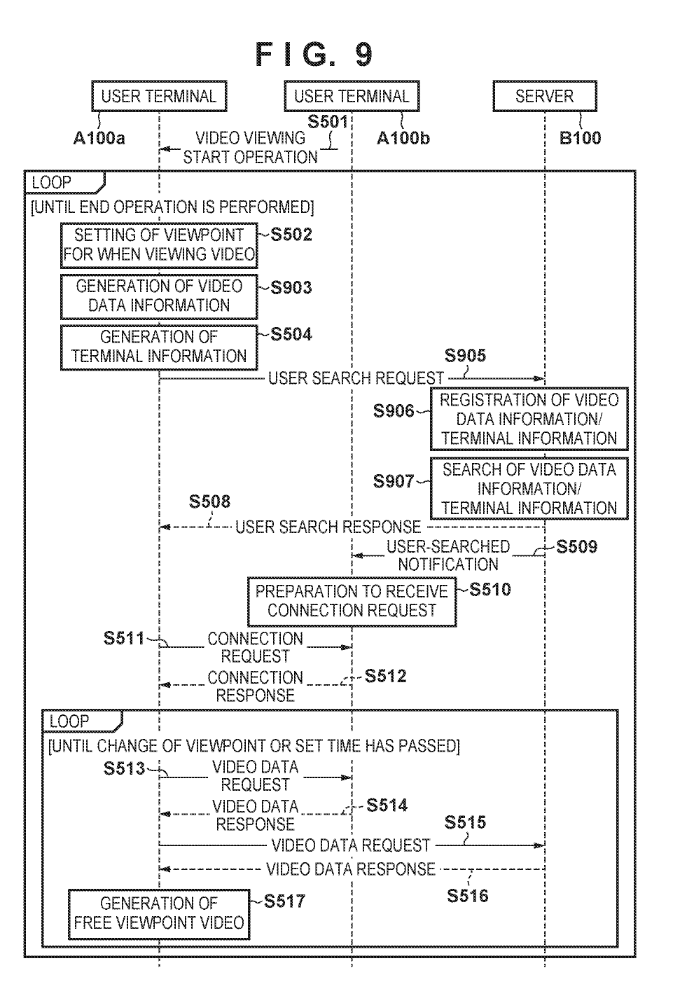

Operations performed by the user terminal A100 and the server B100 according to the present embodiment will be described next using the sequence chart illustrated in FIG. 9.

In FIG. 9, processes that are the same as those described in the first embodiment with reference to FIG. 5 will be given the same step numbers as in FIG. 5, and will not be described. The prerequisite conditions are also assumed to be the same as in the first embodiment.

In S903, the user terminal A100a generates the video data information on the basis of the viewpoint determined in S502. The video data information includes at least the video data ID.

In S905, the user terminal A100a transmits a user search request to the server B100. The user terminal Al00a includes the following information in the user search request.
the video data information generated in S903
the terminal information generated in S504
   This information is merely an example of the user search request.

In S906, the server B100 registers, in the data table T800 of the storage unit B102, the video data information and the terminal information, which are included in the user search request received from the user terminal A100a in S905.

In S907, using the video data information and the video data ID included in the user search request received from the user terminal A100a in S905, the server B100 refers to the data table T800 in the storage unit B102 to search out a record including the same video data ID as the stated video data ID, and acquires the terminal information in that record.

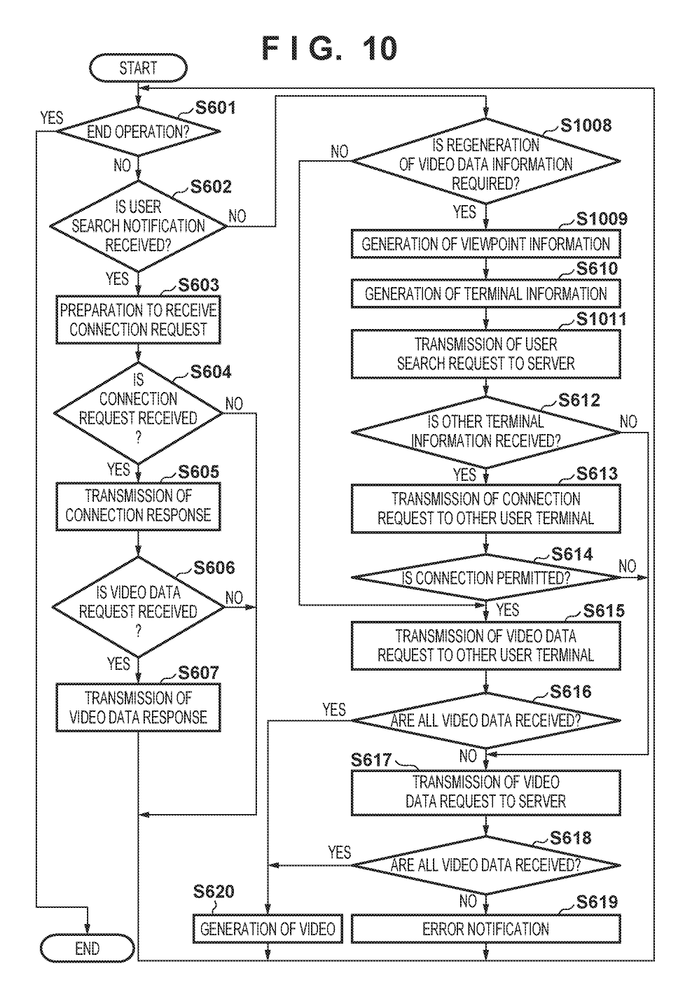

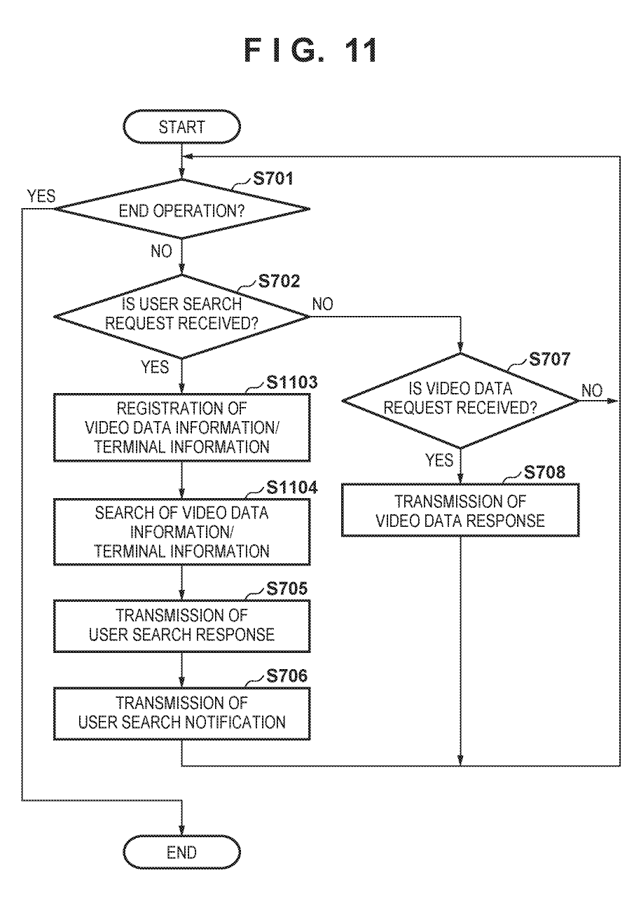

Specific operations performed by the user terminal A100 and the server B100 for realizing the sequence illustrated in FIG. 9 will be described next with reference to FIGS. 10 and 11.

FIG. 10 illustrates the operations carried out by the user terminal A100 according to the present embodiment. In FIG. 10, processes that are the same as those described in the first embodiment with reference to FIG. 6 will be given the same step numbers as in FIG. 6, and will not be described.

In S1008, the control unit A101 determines whether it is necessary to regenerate the video data information. It is determined to be necessary to regenerate the video data information if the video data required to generate the free viewpoint video has changed in response to an operation for changing the viewpoint being made through the operation unit A105, or if a set amount of time has passed following the generation of the video data information. The control unit A101 moves the processing to S1009 if it has been determined that it is necessary to regenerate the video data information. However, the control unit A101 moves the processing to S615 if it has been determined that it is not necessary to regenerate the viewpoint information.

In S1009, the control unit A101 determines the viewpoint position and the gaze position for the current time for viewing the video, on the basis of the states of the storage unit A102, the memory A103, and the operation unit A105. On the basis of the determined viewpoint position and gaze position and the playback time of the video, the control unit A101 generates the video data ID of the video data required to generate the free viewpoint video, and generates the video data information using that video data ID. The video data information includes at least the video data ID. The control unit A101 holds the generated video data information in the storage unit A102 and the memory A103. The process of this step corresponds to the processes of S902 and S603 in FIG. 9.

In S1011, the control unit A101 transmits the user search request to the server B100 through the communication unit A106. The control unit A101 includes the video data information generated in S1009 and the terminal information generated in S610 in the user search request. The process of this step corresponds to the process of S905 in FIG. 9.

FIG. 11 illustrates the operations carried out by the server B100 according to the present embodiment. In FIG. 11, processes that are the same as those described in the first embodiment with reference to FIG. 7 will be given the same step numbers as in FIG. 7, and will not be described.

In S1103, the control unit B101 saves, in the data table T800, the video data information and the following terminal information included in the user search request received from the user terminal A100 in S702. The process of this step corresponds to the process of S906 in FIG. 9.
the video data ID
the global address
the global port number

In S1104, on the basis of the video data ID in the video data information included in the user search request received from the user terminal A100 in S702, the control unit B101 refers to the data table T800 in the storage unit B102 to search out a record including the same video data ID as the stated video data ID, and acquires the terminal information in that record. The process of this step corresponds to the process of S907 in FIG. 9.

According to the present embodiment, the server B100 can search out a user terminal having the video data required to generate the free viewpoint video by referring to the data table T800, which manages which user terminal has which video data, and then transmit the terminal information of that user terminal. This increases the likelihood that a user terminal can acquire the video data from another user terminal.

### Third Embodiment

A third embodiment will be described next.

Depending on the combination of Network Address Translation (NAT) types of the router C100 used by the user terminal to connect to the network D100, there are situations where a P2P connection cannot be established. If a P2P connection cannot be established, the video data required to generate the free viewpoint video cannot be received from another user terminal, and thus the video data is received directly from the server B100.

Accordingly, in the present embodiment, the likelihood that P2P communication will succeed is increased by having the server B100 manage the types of NAT of the router C100 used by the user terminals A100 and transmit the terminal information of another user terminal capable of P2P communication.

The following descriptions will focus upon the differences from the first and second embodiments. Note that the configurations of the user terminal A100 and the server B100 according to the present embodiment are the same as those illustrated in FIG. 1. The system configuration according to the present embodiment is also the same as that illustrated in FIG. 2.

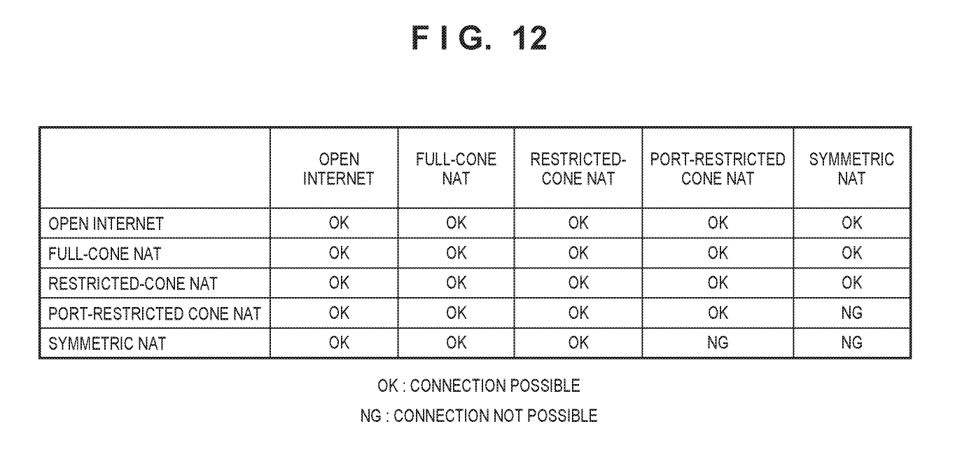

First, the NAT types of the router C100 used by the user terminals A100, and the combinations in which P2P communication can be carried out, according to the present embodiment will be described with reference to FIG. 12.

NAT types can be classified into four types, namely full-cone NAT, restricted-cone NAT, port-restricted cone NAT, and symmetric NAT. The combinations illustrated in FIG. 12 indicate whether or not P2P connections can be established in five types of combinations, which add an open network, where a connection can be made to the network directly without traversing a router, to the aforementioned four types of NAT. In FIG. 12, “OK” indicates a NAT combination in which P2P communication can be carried out, whereas “NG” indicates a NAT combination in which P2P communication cannot be carried out.

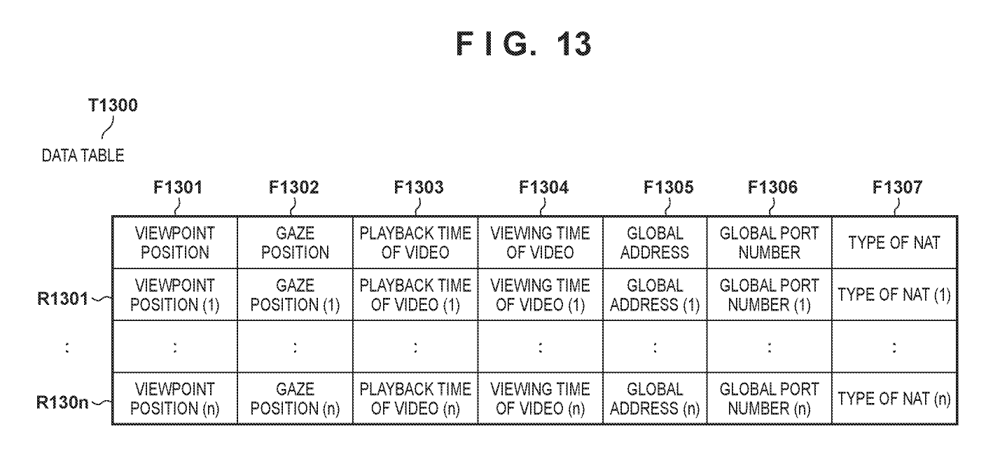

Next, a data table T1300 stored in the storage unit B102 of the server B100 according to the present embodiment will be described with reference to FIG. 13.

The data table T1300 is a data table that adds the NAT type as terminal information to the data table T300 described in the first embodiment with reference to FIG. 3.

The data table T1300 manages data in units of records that consolidate data as indicated by R1301 and so on up to R130n.

Field F1301 to field F1306 in the data table T1300 are the same as the fields F301 to F306 in the data table T300 described in the first embodiment with reference to FIG. 3.

The NAT type, which is managed by a field F1307 in the data table T1300, indicates the NAT type of the router used by the user terminal to connect to the Internet.

Operations performed by the user terminal A100 and the server B100 according to the present embodiment will be described next using the sequence chart illustrated in FIG. 5. Processes in FIG. 5 that are the same as those described in the first embodiment will not be described here.

It is assumed that at the point in time when the sequence in FIG. 5 is started, the user terminal A100a holds the NAT type of a router C100a, which the user terminal A100a uses to connect to the network D100, in the memory A103. Note that the user terminal A100a acquires the NAT type using a technique such as Session Traversal Utilities for NATs (STUN) or the like (see Japanese Patent Laid-open No. 2016-208162).

Likewise, it is assumed that the user terminal A100b holds the NAT type of a router C100b, which the user terminal A100b uses to connect to the network D100, in the memory A103.

In S504, the user terminal A100a generates the terminal information. In the present embodiment, the user terminal A100a generates terminal information that also includes the NAT type of the router C100a.

in S507, as in the first embodiment, the server B100 searches out and acquires the terminal information of another user terminal having a similar viewpoint and playback time and in which the video data is highly likely to be cached, on the basis of the viewpoint information included in the user search request received from the user terminal A100a in S505. In the present embodiment, the server B100 uses the information of the NAT type in the terminal information included in the user search request to narrow down the search to other user terminals with which P2P communication can be carried out.

Operations performed by the user terminal A100 for realizing the sequence according to the present embodiment will be described next with reference to FIG. 6. Processes in FIG. 6 that are the same as those described in the first embodiment will not be described here.

In S610, the control unit A101 generates the terminal information on the basis of the states of the storage unit A102 and the memory A103. In the present embodiment, the user terminal A100a generates terminal information that also includes information of the NAF type of the router C100a. The process of this step corresponds to the process of S504 in FIG. 5.

Operations performed by the server B100 for realizing the sequence according to the present embodiment will be described next with reference to FIG. 7. Processes in FIG. 7 that are the same as those described in the first embodiment will not be described here.

In S704, the control unit B101 searches out and acquires the terminal information of another user terminal having a similar viewpoint and playback time and in which video data is highly likely to remain, on the basis of the viewpoint information included in the user search request received from the user terminal A100 in S702. In the present embodiment, the server B100 uses the information of the NAT type in the terminal information included in the user search request to narrow down the search to other user terminals with which P2P communication can be carried out. The process of this step corresponds to the process of S507 in FIG. 5.

According to the present embodiment, the server B100 manages the NAT types of the routers used by the user terminals A100, and transmits the terminal information to other user terminals capable of P2P communication as the user search response. As a result, P2P connection failures between user terminals caused by NAT type combinations can be eliminated. Furthermore, processing loads on the server arising when the video data required to generate the free viewpoint video cannot be received from other user terminals can be reduced.

### Fourth Embodiment

A fourth embodiment will he described next.

In the above-described first to third embodiments, the user terminals generate the free viewpoint video using the video data, and thus a user terminal that does not have the capability or meet the conditions for generating free viewpoint video cannot generate the free viewpoint video.

Accordingly, in the present embodiment, the server B100 manages the capabilities of the user terminals, and for a high-performance user terminal having the capability to generate the free viewpoint video, the server B100 transmits the terminal information of another user terminal having the video data as the user search response in the same manner as in the first embodiment. On the other hand, for a low-performance user terminal that does not have the capability to generate the free viewpoint video, the terminal information of another user terminal having free viewpoint video data that has already been generated is transmitted as the user search response. This makes it possible to view the free viewpoint video regardless of the capabilities of the user terminal.

The following descriptions will focus upon the differences from the first to third embodiments. Note that the configurations of the user terminal A100 and the server B100 according to the present embodiment are the same as those illustrated in FIG. 1. The system configuration according to the present embodiment is also the same as that illustrated in FIG. 2.

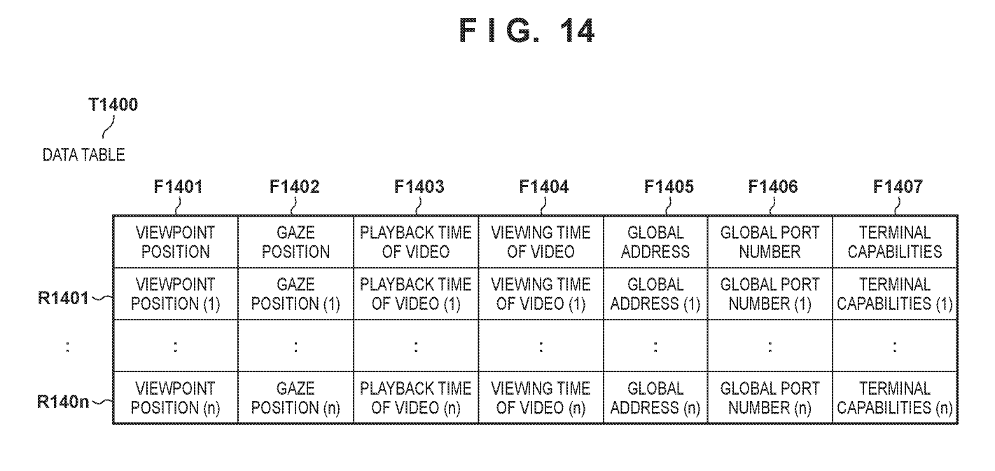

First, a data table T1400 stored in the storage unit B102 of the server B100 according to the present embodiment will be described with reference to FIG. 14.

The data table T1400 is a data table that adds terminal capabilities as terminal information to the data table T300 described in the first embodiment with reference to FIG. 3.

The data table T1400 manages data in units of records that consolidate data as indicated by R1401 and so on up to R140n.

The terminal capabilities, which are managed by a field F1407 in the data table T1400, indicate capability information pertaining to the generation of the free viewpoint video by each user terminal. This information is used to determine whether or not the user terminal can generate the free viewpoint video. This information may be frames per second (FPS) or the like indicating the terminal capabilities of the user terminal per unit of time.

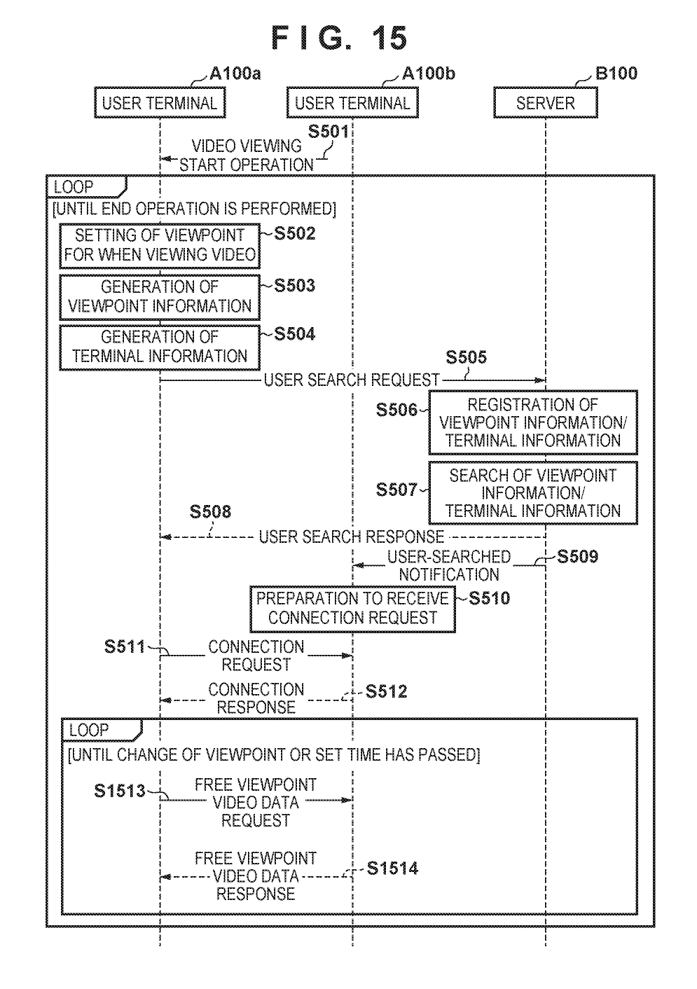

Operations performed by the user terminal A100 and the server B100 according to the present embodiment will be described next using the sequence chart illustrated in FIG. 15.

The present embodiment differs from the first embodiment in that it is assumed that there is a terminal, among the user terminals A100, that has low terminal capabilities and therefore cannot generate the free viewpoint video.

If the user terminal A100 can generate the free viewpoint video, the operations of the user terminal A100 and the server B100 according to the present embodiment are the same as those described in the first embodiment with reference to FIG. 5. FIG. 15 illustrates operations carried out if the user terminal A100 has low terminal capabilities and therefore cannot generate the free viewpoint video.

In FIG. 15, processes that are the same as those described in the first embodiment with reference to FIG. 5 will be given the same step numbers as in FIG. 5, and will not be described.

It is assumed that at the point in time when the sequence illustrated in FIG. 15 is started, the user terminal A100 holds its own terminal capabilities in the memory A103. It is also assumed here that the terminal capabilities have been acquired in advance using a benchmarking tool, hardware specification information, or the like.

In S504, the user terminal A100a generates the terminal information. The user terminal A100a generates the terminal information including information of its own terminal capabilities as well.

In S507, the server B100 searches out and acquires the terminal information of another user terminal, using the terminal information included in the user search request transmitted from the user terminal A100a in S505. The search differs depending on the terminal capabilities included in the terminal information transmitted from the user terminal A100a. If the terminal capabilities are high and the free viewpoint video can be generated, a terminal having a similar viewpoint and playback time, and which is highly likely to have the video data cached, is searched out and acquired from the group of other user terminals, in the same manner as in the first embodiment. However, if the terminal capabilities are low and the free viewpoint video cannot be generated, a terminal having a similar viewpoint and playback time, and which is highly likely to have cached free viewpoint video data that has already been generated, is searched out and acquired from the group of other user terminals.

In S1513, the user terminal A100a transmits a free viewpoint video data request to the user terminal A100b in order to request the free viewpoint video data. The free viewpoint video data request includes the viewpoint information.

In S1514, if the free viewpoint video data requested by the user terminal A100a in S513 is present, the user terminal A100b transmits the free viewpoint video data to the user terminal A100a as a free viewpoint video data response.

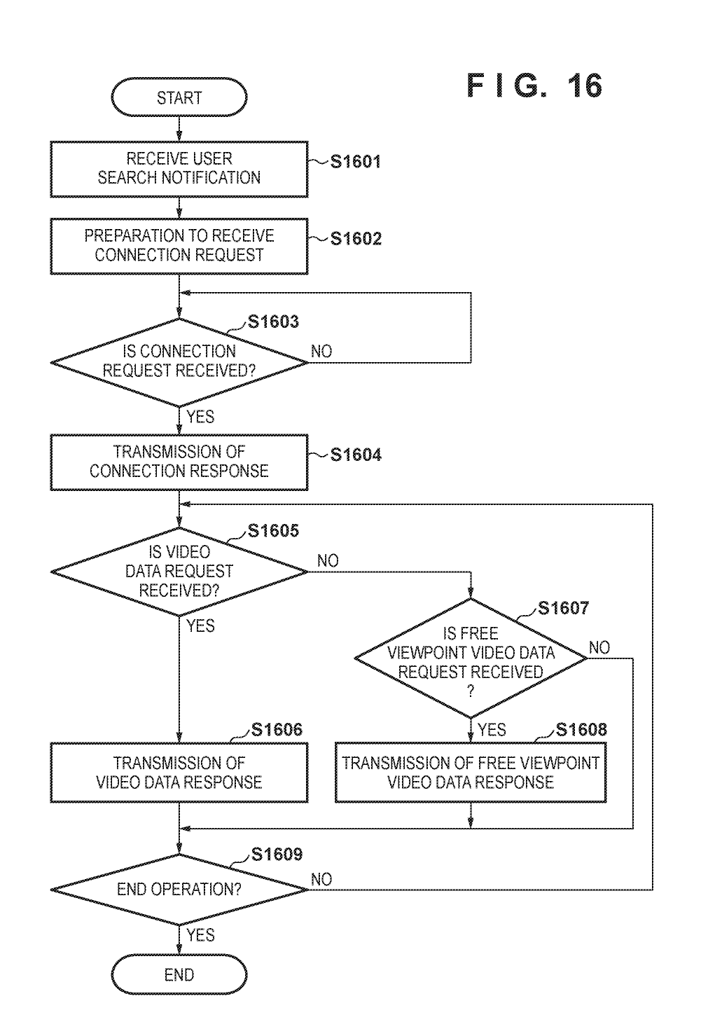

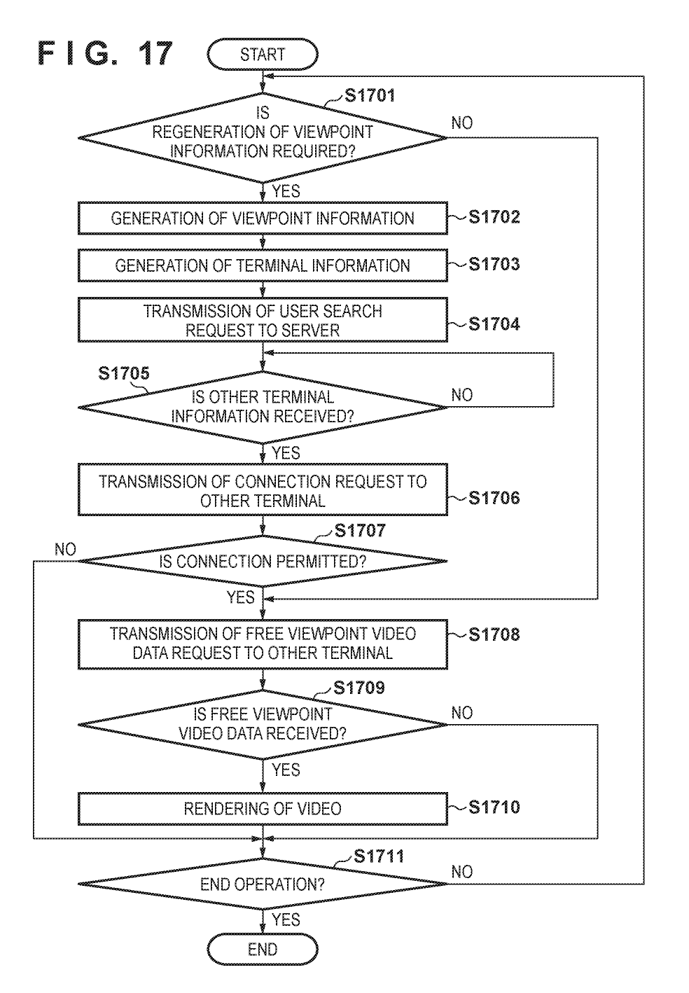

Operations performed by the server B100 for realizing the sequence according to the present embodiment will be described next with reference to FIGS. 16 and 17.

FIG. 16 illustrates operations performed by the user terminal A100 when a user search notification has been transmitted from the server B100.

In S1601, the control unit A101 determines whether the user search notification has been received from the server B100 through the communication unit A106.

In S1602, the control unit A101 prepares to receive a connection request transmitted from another user terminal. For example, hole punching or the like is carried out through the communication unit A106 in order to establish P2P communication with a user terminal. The process of this step corresponds to the process of S510 in FIG. 15.

In S1603, the control unit A101 determines whether a connection request has been received from another user terminal through the communication unit A106. The process moves to S1604 if it is determined that the connection request has been received, and the process of S1603 is repeated if it is determined that the connection request has not been received.

In S1604, the control unit A101 transmits a connection response to the other user terminal through the communication unit A106 in response to the connection request. The process of this step corresponds to the process of S512 in FIG. 15.

In S1605, the control unit A101 determines whether a video data request has been received from the other user terminal through the communication unit A106. The process moves to S1606 if it is determined that the video data request has been received, and the process moves to S1607 if it is determined that the video data request has not been received.

In S1606, the control unit A101 transmits the video data requested by the video data request to the other user terminal through the communication unit A106 as a video data response. If the video data is not present, the control unit A101 transmits an indication to that effect to the other user terminal through the communication unit A106.

In S1607, the control unit A101 determines whether a free viewpoint video data request has been received from the other user terminal through the communication unit A106. The process moves to S1608 if it is determined that the free viewpoint video data request has been received, and the process moves to S1609 if it is determined that the free viewpoint video data request has not been received.

In S1608, the control unit A101 transmits the free viewpoint video data requested by the free viewpoint video data request to the other user terminal through the communication unit A106 as a free viewpoint video data response. If the free viewpoint video data is not present, the control unit A101 transmits an indication to that effect to the other user terminal through the communication unit A106.

In S1609, the control unit A101 determines whether or not to terminate the processing on the basis of the state of the units in the user terminal A100. The processing of this flowchart ends if the control unit Al 01 has determined that the processing is to be terminated. However, the processing moves to S1605 if the control unit A101 has determined that the processing is to be continued.

FIG. 17 illustrates operations carried out when the free viewpoint video is viewed in a user terminal A100 that has low terminal capabilities and therefore cannot generate the free viewpoint video. However, a user terminal A100 that has high terminal capabilities and therefore can generate the free viewpoint video carries out the same operations as those illustrated in FIG. 6.

In S1701, the control unit A101 determines whether it is necessary to regenerate the viewpoint information. It is determined that the regeneration is necessary if an operation for changing the viewpoint has been carried out or a set amount of time has passed following the previous time the viewpoint information was generated. The control unit A101 moves the processing to S1702 if it has been determined that it is necessary to regenerate the viewpoint information. However, the control unit A101 moves the processing to S1708 if it has been determined that it is not necessary to regenerate the viewpoint information.

In S1702, the control unit A101 generates the viewpoint information through the same processing as that of S609 in FIG. 6. The process of this step corresponds to the process of S503 in FIG. 15.

In S1703, the control unit A101 generates the terminal information on the basis of the states of the storage unit A102 and the memory A103. In the present embodiment, it is assumed that the terminal information also includes information of the terminal's own terminal capabilities. The process of this step corresponds to the process of S504 in FIG. 15.

In S1704, the control unit A101 transmits the user search request to the server 13100 through the communication unit A106. The user search request includes the viewpoint information generated in S1702 and the terminal information generated in S1703. The process of this step corresponds to the process of S505 in FIG. 15.

In S1705, the control unit A101 determines whether other user terminal information has been received from the server B100 through the communication unit A106 as the user search response. The process moves to S1706 if it is determined that the other user terminal information has been received, and the process of S1705 is repeated if it is determined that the other user terminal information has not been received.

In S1706, the control unit A101 transmits the connection request to the other user terminal through the communication unit A106, on the basis of the other user terminal information received from the server B100 in S1705. The process of this step corresponds to the process of S511 in FIG. 15.

In S1707, the control unit A101 receives a connection response from the other user terminal through the communication unit A106 and determines whether connection permission has been obtained. The processing moves to S1708 if the control unit A101 has determined that connection permission has been obtained. The processing moves to S1711 if the control unit A101 has determined that connection permission has not been obtained. The process of this step corresponds to the process of S512 in FIG. 15.

In S1708, the control unit A101 transmits information required to designate free viewpoint video data to the other user terminal through the communication unit A106 as a free viewpoint video data request. The process of this step corresponds to the process of S1513 in FIG. 15.

In S1709, the control unit A101 determines whether the free viewpoint video data requested in S1708 has been received through the communication unit A106 as the free viewpoint video data response from the other user terminal. The processing moves to S1710 if the control unit A101 has determined that all the free viewpoint video data has been received. The processing moves to S1711 if the control unit A101 has determined that not all the free viewpoint video data has been received.

In S1710, the control unit A101 saves the free viewpoint video data received in 51709 in the storage unit A102. The control unit A101 reads out the free viewpoint video data saved in the storage unit A100 the memory A103, and displays the data in the display unit A104.

In S1711, the control unit A101 determines whether or not to terminate the processing on the basis of the state of the user terminal A100. The processing of this flowchart ends if the control unit A101 has determined that the processing is to be terminated. However, the processing moves to S1701 if the control unit A101 has determined that the processing is to be continued.

Note that the user search response in S1705 may include the following terminal information. This makes it possible for the user terminal that has made the transmission to connect to any one of the following other user terminals and receive the free viewpoint video data request.
information of another user terminal having free viewpoint video that has the same composition as that of the user terminal that transmitted the user search request
information of another user terminal in which the viewpoint information is the closest to that of the user terminal that transmitted the user search request
information of another user terminal having video data for generating free viewpoint video that the user wishes to view
information of another user terminal having reserve processing abilities
   This makes it possible for the user terminal that made the transmission to . . . another user terminal

If the user search response includes the terminal information of a plurality of other user terminals in S1705, connection requests may be transmitted to the plurality of other user terminals in S1706, and free viewpoint video data requests may be transmitted to the plurality of other user terminals in S708. As a result, different frames of the free viewpoint video data, different regions of the free viewpoint video data, and so on may be received from the plurality of other user terminals and combined.

Operations performed by the server B100 for realizing the sequence according to the present embodiment will be described next with reference to FIG. 7. Processes in FIG. 7 that are the same as those described in the first embodiment will not be described here.

In S704, the control unit B101 searches out and acquires the terminal information of another user terminal having a similar viewpoint position and playback time, using the viewpoint information included in the user search request transmitted from the user terminal A100 in S702. In the present embodiment, when the user terminal has high terminal capabilities and therefore can generate the free viewpoint video, the terminal information included in the user search request is used to narrow the search down to the user terminals highly likely to have the video data cached. However, when the user terminal has low terminal capabilities and therefore cannot generate the free viewpoint video, the search is narrowed down to the user terminals highly likely to have the free viewpoint video data cached.

According to the present embodiment, the server B100 manages the terminal capabilities of the user terminal A100, and if the user terminal A100 has low terminal capabilities and therefore cannot generate the free viewpoint video, the server B100 transmits the terminal information of another user terminal having the free viewpoint video data which has already been generated. This makes it possible to view the free viewpoint video even with a user terminal having low terminal capabilities.

### Fifth Embodiment

A fifth embodiment will be described next.

The present embodiment will describe processing carried out when moving the viewpoint.

First, viewpoint movement according to the present embodiment will be described using FIG. 4.

The present embodiment assumes that when, for example, viewing a sports competition at a stadium, a major change in the viewpoint, e.g. from the current viewpoint to a viewpoint on the opposite side, is made. In FIG. 4, the viewpoint moves from a viewpoint where the video data from the camera E100a and the camera E100b is required, to a viewpoint where the video data from the camera E100j and the camera E100i is required.

When such viewpoint movement occurs, the video data which will be necessary to generate the post-move free viewpoint video will almost never be present in the other user terminals with which connections are already established, and it is therefore necessary to make new connections with other user terminals and acquire the video data. There is thus an issue in that it takes time from when the user terminal accepts an operation to move to viewpoint to when the video data is actually acquired.

Thus in the present embodiment, when a major move in the viewpoint is made, the free viewpoint video is generated using video data received from another user terminal in a viewpoint position similar to a viewpoint position designated by the user as a move destination. The above issue is solved by establishing a connection with another user terminal close to the viewpoint position at the move destination in advance.

The following descriptions will focus upon the differences from the first to fourth embodiments. Note that the configurations of the user terminal A100 and the server B100 according to the present embodiment are the same as those illustrated in FIG. 1. The system configuration according to the present embodiment is also the same as that illustrated in FIG. 2.

Although the storage unit B102 of the server B100 has the same configuration as that illustrated in FIG. 1, the storage unit B102 stores a move destination table T1800 (described later) in addition to the data table T300.

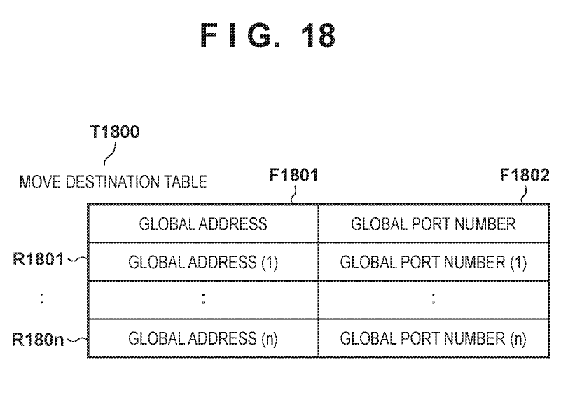

First, the move destination table T1800 stored in the storage unit B102 of the server B100 according to the present embodiment will be described with reference to FIG. 18.

In the present embodiment, the server B100 divides the viewpoint positions in the stadium into uniform areas, and takes the center position of each area as a move destination viewpoint position. A user terminal A100 viewing the free viewpoint video at a viewpoint position close to the center position of each area is selected as a move destination terminal.

The move destination table T1800 manages data in units of records that consolidate data as indicated by R1801 and so on up to R180n.

The terminal information of the move destination terminals is registered in the move destination table T1800, and is used by the user terminals A100 to establish connections with the move destination terminals. Like the data table T300 described in the first embodiment with reference to FIG. 3, the terminal information includes a global address 1801 and a global port number 1802 as information required for user terminals to connect to each other.

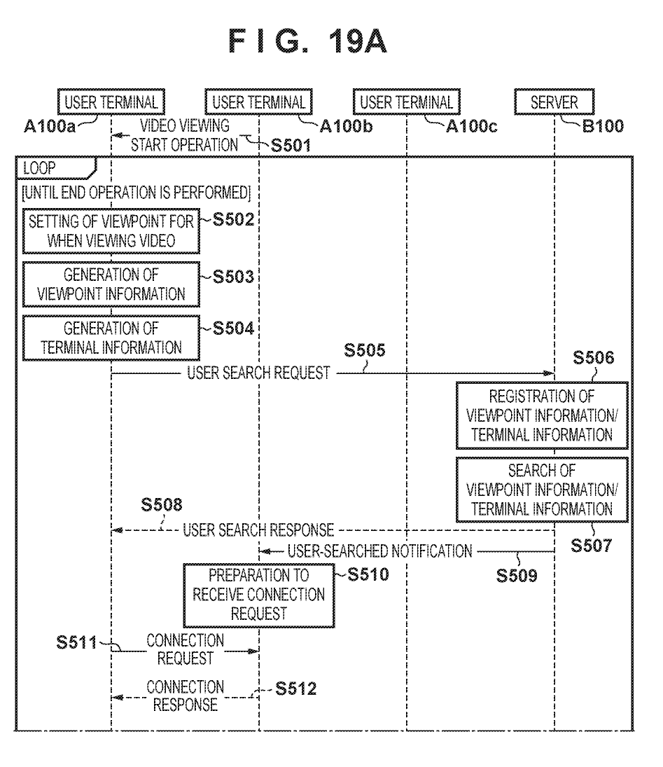

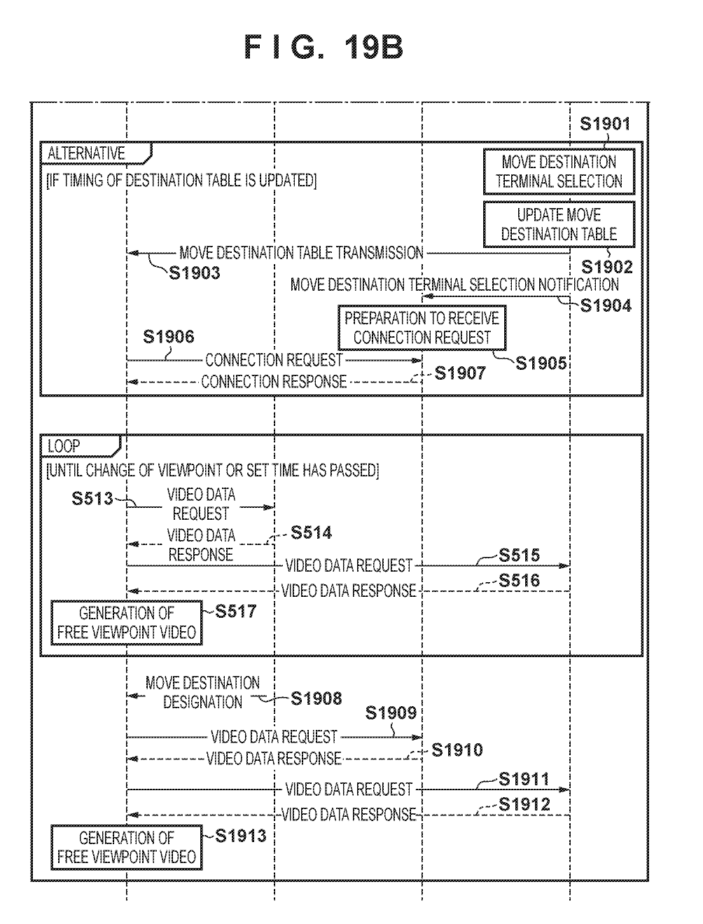

Operations performed by the user terminal A100 and the server B100 for realizing the sequence according to the present embodiment will be described next with reference to FIGS. 19A and 19B.

It is assumed that the user terminal A100a receives some of the necessary video data from the user terminal A100b, which has similar viewpoint information. The user terminal A100c is assumed to be one move destination terminal. Furthermore, it is assumed that the viewpoint information and the terminal information of the user terminal A100b and the user terminal A100c is registered in the server B100. Finally, it is assumed that the user terminal A100b and the user terminal A100c do not have the same video data.

The following will describe an example of operations when the viewpoint of the user terminal A100a has moved from near the viewpoint of the user terminal A100b to near the viewpoint of the user terminal A100c.

If it is determined that it is necessary to update the move destination table T1800, the server B100 carries out S1901 and determines the move destination viewpoint position. A user terminal viewing the free viewpoint video at a viewpoint position close to the center position of each area is selected as the move destination terminal. The method for selecting the move destination terminal is not limited to the above-described method. For example, the method may be such that the number of records having the same viewpoint position is totaled by referring to the data table T300, and the viewpoint having the highest number of records is selected so as to select the user terminal at a viewpoint position to which the viewpoint can easily move. It is also assumed that the move destination table T1800 is updated every set period.

In S1902, the server B100 adds the record of the user terminal A100c to the move destination table T1800.

In S1903, the server B100 transmits the move destination table T1800 to the user terminal A100a.

In S1904, the server B100 transmits a move destination terminal selection notification to the user terminal A100c, which is the move destination terminal. Note that the move destination terminal selection notification is constituted by a flag for discriminating between the terminal information and the user search notification.

In S1905, the user terminal A100c prepares to receive a connection request. Note that the preparation to receive the connection request carried out in S1905 is the same processing as that carried out in S510 of FIG. 5.

In S1906, the user terminal A100a refers to the terminal information registered in the move destination table T1800, and transmits a connection request. Note that the process for transmitting the connection request in S1906 is the same as the process of S511 in FIG. 5.

In S1907, the server B100 transmits a connection response to the user terminal A100a. Note that the process for transmitting the connection response in S1907 is the same as the process of S512 in FIG. 5.

In the present embodiment, a connection is established in advance between the user terminal A100a and the user terminal A100c as per S1901 to S1907, and the video data request is then made for the first time after the move destination has been designated in S1908.

In S1908, the user terminal A100a accepts an operation for designating the move destination. It is assumed that in FIG. 19B, the user terminal A100a accepts an operation for moving to the user terminal A100c.

The processing from S1909 to S1913 is the same as that from S513 to S517 in FIG. 5, and thus descriptions thereof will not be given.

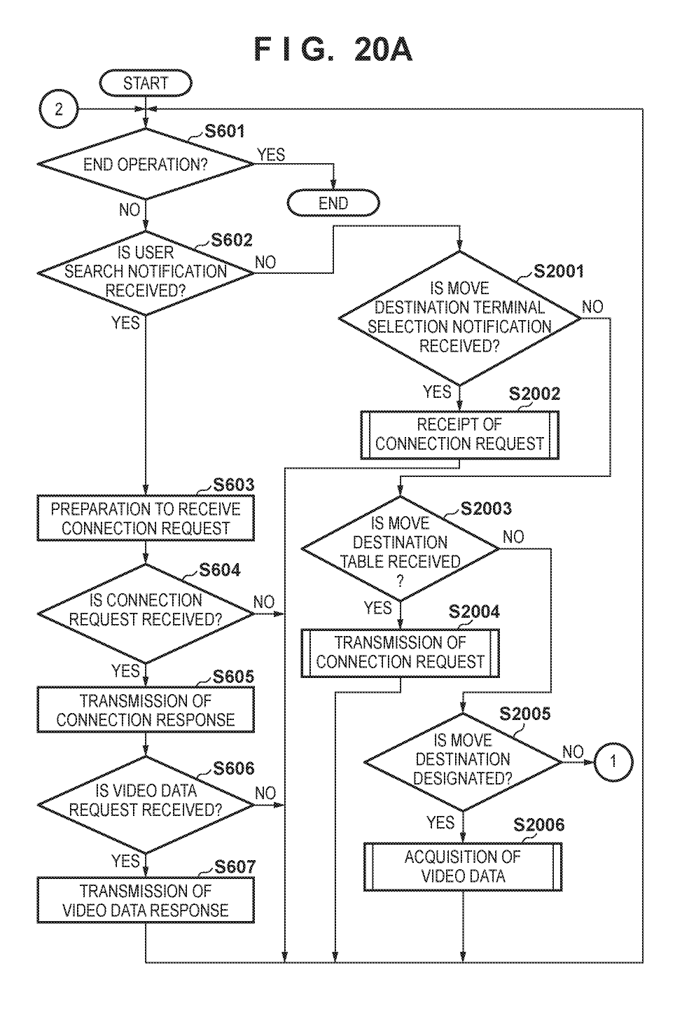

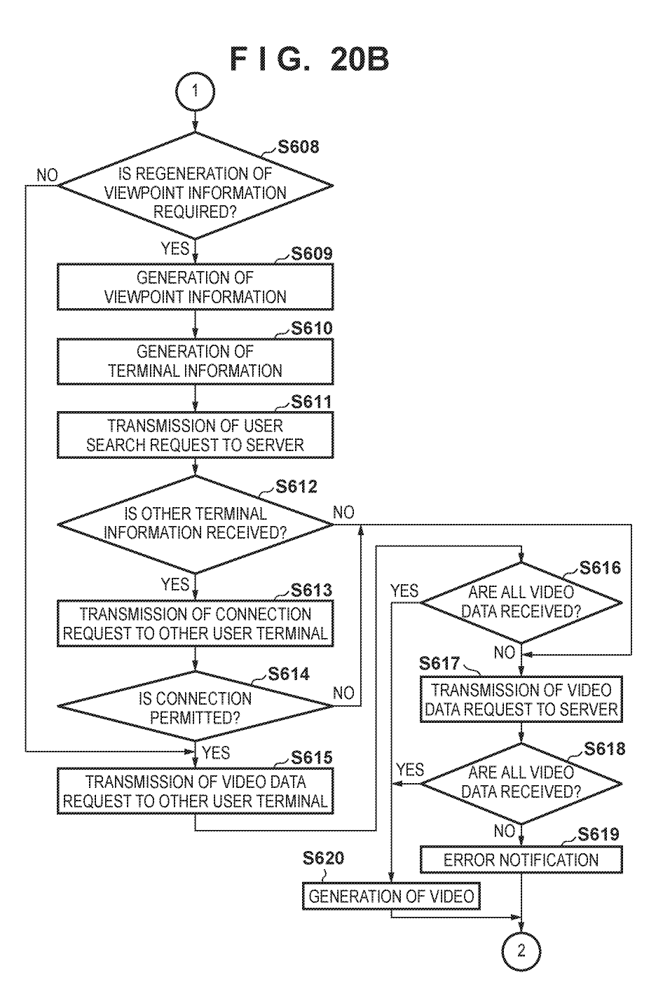

Operations performed by the user terminal A100 for realizing the sequence according to the present embodiment will be described next with reference to FIGS. 20A and 20B.

In the present embodiment, the following processes are added to the processing described in the first embodiment with reference to FIG. 6.
determining whether or not the terminal has been selected as the move destination terminal, and processing carried out if the terminal has been selected (S2001 and S2002 in FIG. 20A)
determining whether or not the move destination terminal has been updated by the server B100, and processing carried out if the terminal has been updated (S2003 and S2004 in FIG. 20A)
determining whether or not a move destination has been designated for the viewpoint of the user terminal, and processing for starting data communication if the destination has been designated (S2005 and S2006 in FIG. 20A)

Note that the processing aside from S2001 to S2006 is the same as that described in the first embodiment with reference to FIG. 6, and thus descriptions thereof will not be given.

In S2001, the control unit A101 determines whether a move destination terminal selection notification has been received from the server B100 through the communication unit A106. The processing moves to S2002 if the control unit A101 has determined that the move destination terminal selection notification has been received. The processing moves to S2003 if the control unit A101 has determined that the move destination terminal selection notification has not been received.

In S2002, the user terminal A100 receives a connection request.

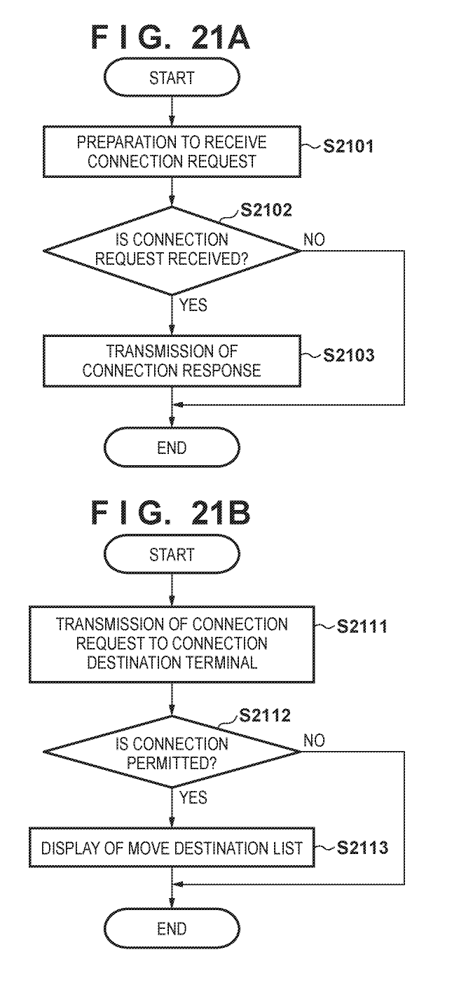

The process of S2002 will be described here using FIG. 21A.

In S2101, the control unit A101 prepares to receive a connection request. This step is the same as the process of S603 in FIG. 6. The process of this step corresponds to the processes of S1904 and S1905 in FIG. 19B.

In S2102, the control unit A101 determines whether or not the connection request has been received. This step is the same as the process of S604 in FIG. 6. The processing moves to S2103 if the control unit A101 has determined that a connection request has been received. However, the processing ends if the control unit A101 has determined that a connection request has not been received.

In S2103, the control unit A101 transmits a connection response. This step is the same as the process of S605 in FIG. 6. The process of this step corresponds to the process of S1907 in FIG. 19B.

In S2003, the control unit A101 determines whether the move destination table T1800 has been received from the server B100 through the communication unit A106. The processing moves to S2004 if the control unit A101 has determined that the move destination table T1800 has been received. The processing moves to S2005 if the control unit A101 has determined that the move destination table T1800 has not been received.

In S2004, the user terminal A100 transmits a connection request.

The process of S2004 will be described here using FIG. 21B.

In S2111, the control unit A101 transmits the connection request to the other terminal through the communication unit A106, on the basis of the terminal information in the move destination table T1800 received from the server B100 in S2003. The process of this step corresponds to the process of S1906 in FIG. 19B.

In S2112, the control unit A101 receives a connection response from the other user terminal through the communication unit A106 and determines whether connection permission has been obtained. The processing moves to S2113 if the control unit A101 has determined that connection permission has been obtained. The processing ends if the control unit A101 has determined that connection permission has not been obtained.

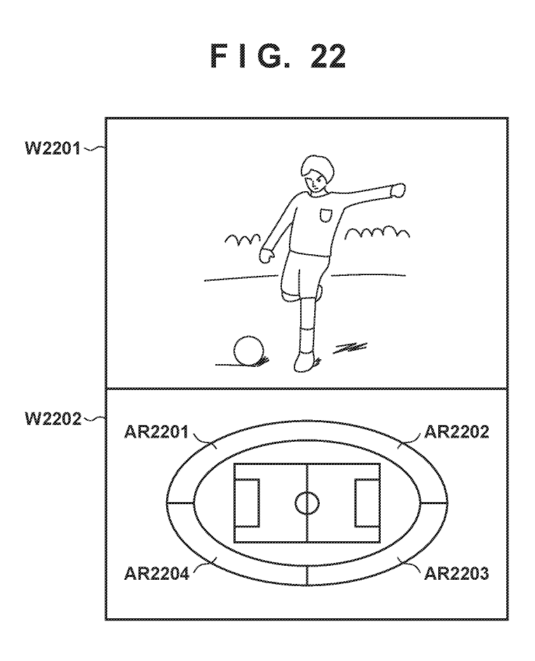

In S2113, the control unit A101 updates a move destination list GUI in the display unit A104. FIG. 22 illustrates an example of the move destination list GUI displayed in the display unit A104.

W2201 indicates a display region of the free viewpoint video. W2202 indicates a display region for the move destination list. FIG. 22 illustrates a state in which the move destination has been extracted at equal intervals from four regions, i.e. areas AR2201 to AR2204, and the user has designated the move destination by selecting one of AR2201 to AR2204 through the operation unit A105.

In S2005, the control unit A101 determines whether or not an operation for designating the move destination has been made through the operation unit A105. The control unit A101 moves the processing to S2006 if it has been determined that an operation for designating the move destination has been made. The control unit A101 moves the processing to S608 if it has been determined that an operation for designating the move destination has not been made. The process of this step corresponds to the process of S1908 in FIG. 19B.

In S2006, the user terminal A100 acquires the video data.

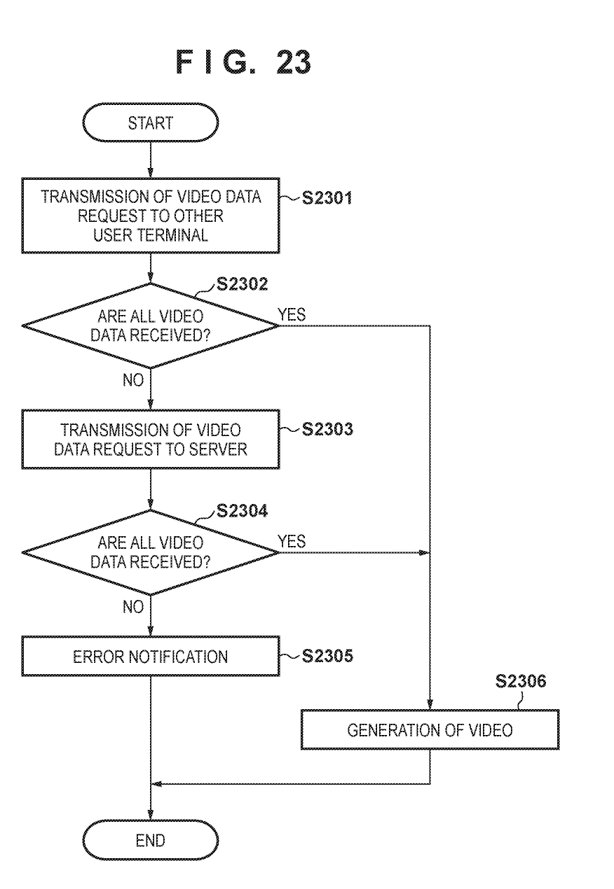

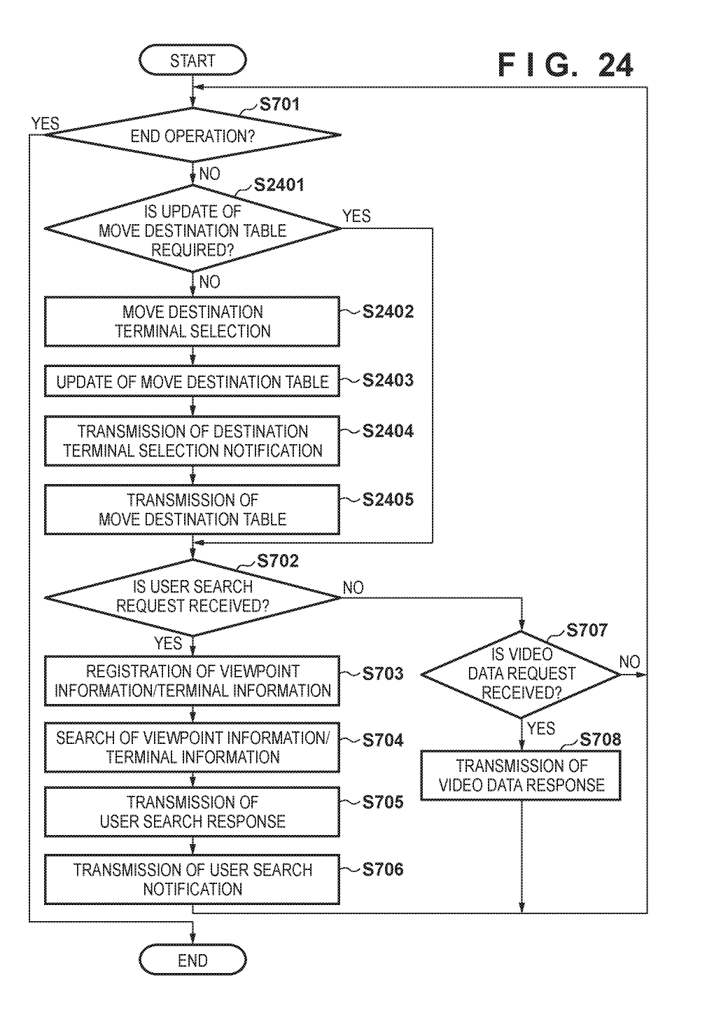

The process of S2006 will be described here using FIG. 23.

The processing from S2301 to S2306 is the same as that from S615 to S620 in FIG. 6, and thus descriptions thereof will not be given. Note that S2301 corresponds to S1909 in FIG. 19B; S2303, to S1911 in FIG. 19B, and S2306, to S1913 in FIG. 19B.

Operations performed by the server B100 for realizing the sequence according to the present embodiment will be described next with reference to FIG. 24.

In the present embodiment, move destination terminal update processing (S2401 to S2405 in FIG. 24) is added to the processing described in the first embodiment with reference to FIG. 7.

In S2401, the control unit A101 determines whether or not it is necessary to update the move destination table T1800. The processing moves to S702 if the control unit B101 has determined that it is necessary to update the move destination table T1800. The processing moves to S2402 if the control unit B101 has determined that it is not necessary to update the move destination table T1800.

In S2402, the move destination terminal is selected. This step corresponds to S1901 in FIG. 19B.

In S2403, the control unit B101 acquires the record in the data table T300 corresponding to the move destination terminal selected in S2402, and updates the move destination table T1800 by copying the terminal information to the move destination table T1800. This step corresponds to S1902 in FIG. 19B.

In S2404, the control unit B101 transmits a move destination terminal selection notification to the move destination terminal selected in S2402 through the communication unit B107. This step corresponds to S1904 in FIG. 19B.

In S2405, the control unit B101 transmits the move destination table T1800 to all the user terminals A100 registered in the data table T300 in the storage unit B102, through the communication unit B107.

As described thus far, according to the present embodiment, the server B100 determines the move destination of the user terminal A100 in advance and establishes communication. This makes it possible, when making a major front-rear or left-right move to the opposite side of the stadium, to shorten the time taken from when the operation for moving the viewpoint is accepted by the user terminal to when the video data is acquired.

### Sixth Embodiment

A sixth embodiment will be described next.

The fifth embodiment describes a process in which the server establishes communication with the user terminal selected as the move destination in advance. However, it is not necessarily the case that the viewpoint can be moved to the user's intended viewpoint position. It is thus assumed that after a major move is made, the user will move the viewpoint again, to a better viewpoint position. Even when moving the viewpoint again in this manner, it is necessary to shorten the amount of time from when the user terminal accepts the operation to move the viewpoint to when the video data is acquired.

Thus in the present embodiment, after a major move is made, another user terminal that is acquiring video data from a camera close to the viewpoint of the move destination is selected in advance as the move destination and connected to, which shortens the amount of time until the video data is acquired when making another move.

The following descriptions will focus upon the differences from the fifth embodiment. Note that the configurations of the user terminal A100 and the server B100 according to the present embodiment are the same as those illustrated in FIG. 1. The system configuration according to the present embodiment is also the same as that illustrated in FIG. 2.

Operations performed by the user terminal A100 and the server B100 for realizing the sequence according to the present embodiment will be described first with reference to FIGS. 19A and 19B.

After the user terminal A100a has acquired the video data from the move destination terminal and finished generating the free viewpoint video (S1913), the user terminal A100a transmits a proximate terminal search request to the server B100. The proximate terminal search request includes the terminal information and the viewpoint information of the user terminal A100a and an identifier for identifying the proximate terminal search request.

Upon receiving the proximate terminal search request, the server B100 generates a proximate move destination table. The proximate move destination table includes the terminal information of a user terminal acquiring the video data of the camera E100 near the viewpoint position of the user terminal A100a, and an identifier for identifying the proximate move destination table.

Furthermore, the server B100 transmits the proximate move destination table to the user terminal A100a.

On the other hand, upon receiving the proximate move destination table, the user terminal A100a handles the terminal information in the proximate move destination table in the same way as the terminal information in the move destination table T1800, and carries out the processing of S1904 to S1907. As a result, the user terminal A100a connects to all the user terminals associated with the terminal information in the proximate move destination table.

Operations performed by the user terminal A100 for realizing the sequence according to the present embodiment will be described next with reference to FIGS. 20A and 20B.

After finishing the acquisition of the video data (S2006), the control unit A101 transmits the proximate terminal search request to the server B100 through the communication unit A106.

Next, it is determined whether or not the proximate move destination table has been received from the server B100 through the communication unit A106. If it is determined that the proximate move destination table has been received, the control unit A101 handles the proximate move destination table in the same way as the move destination table T1800, and carries out a process for connecting with a user terminal in the same manner as S2004. The processing moves to S601 if the control unit A101 has determined that the proximate move destination table has not been received.

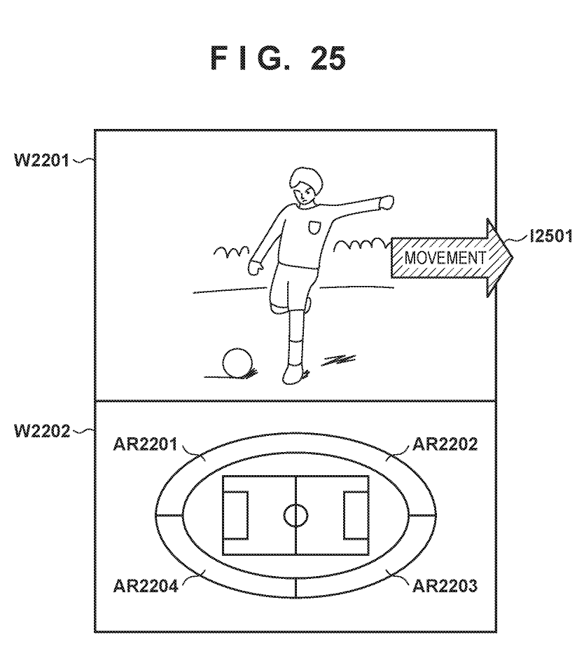

Once the connection is established, the control unit A101 sequentially displays, in the display unit A104, an indication that the viewpoint can be moved in the direction corresponding to the terminal information in the proximate move destination table, as indicated by I2501 in FIG. 25. Here, FIG. 25 illustrates an example where a display indicating that movement to the right is possible has been added to the GUI in FIG. 22.

Operations performed by the server B100 for realizing the sequence according to the present embodiment will be described next with reference to FIG. 24.

If it is determined in S707 that the video data request has not been received, the control unit B101 determines whether or not the proximate terminal search request has been received. If it is determined that the proximate terminal search request has been received, the control unit B101 generates the proximate move destination table and transmits the proximate move destination table to the user terminal A100 through the communication unit B107. However, the processing moves to S701 if the control unit B101 has determined that the proximate terminal search request has not been received.

According to the present embodiment, the time from when the user terminal accepts an operation to move the viewpoint to when the video data is acquired can be shortened even when moving the viewpoint again after a major move.

### Other Embodiments

Embodiments of the invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e,g., central processing unit (CPU), Micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the invention has been described with reference o exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-254395, filed Dec. 28, 2017 which is hereby incorporated by reference herein in its entirety.

What is claimed is:

1. An information processing apparatus which generates free viewpoint video, in which a virtual viewpoint can be changed, using video data shot from a plurality of directions, the apparatus comprising:
a communication unit configured to receive, from a video delivery apparatus, video data for generating the free viewpoint video at a predetermined viewpoint;
a generation unit configured to generate the free viewpoint video at the predetermined viewpoint from the video data received from the video delivery apparatus;
a display unit configured to display the free viewpoint video; and
a control unit configured to carry out control so that when another information processing apparatus, which generates the free viewpoint video at a viewpoint included in a predetermined range from the predetermined viewpoint, is present, communication is carried out with the other information processing apparatus, and the free viewpoint video at the predetermined viewpoint is generated using video data received from the other information processing apparatus.

2. The apparatus according to claim 1, wherein
when the other information processing apparatus has video data for generating the free viewpoint video at the predetermined viewpoint, the control unit carries out control for communicating with the other information processing apparatus and generating the free viewpoint video at the predetermined viewpoint using the video data received from the other information processing apparatus; and
when the other information processing apparatus does not have video data for generating the free viewpoint video at the predetermined viewpoint, the control unit carries out control for generating the free viewpoint video at the predetermined viewpoint using video data received from the video delivery apparatus.

3. The apparatus according to claim 1, wherein
the control unit transmits a search request for the other information processing apparatus to the video delivery apparatus; and
the control unit carries out control so as to communicatively connect to the other information processing apparatus using device information of the other information processing apparatus received from the video delivery apparatus as a response to the search request, and receive video data for generating the free viewpoint video from the other information processing apparatus.

4. The apparatus according to claim 3, wherein
the search request includes at least viewpoint information pertaining to the predetermined viewpoint and device information of the information processing apparatus that transmitted the search request; and
the response to the search request includes the device information of the other information processing apparatus.

5. The apparatus according to claim 3, wherein
the search request includes information pertaining to the video data for generating the free viewpoint video at the predetermined viewpoint; and
the response to the search request includes the device information of another information processing apparatus that has video data for generating the free viewpoint video at the predetermined viewpoint.

6. The apparatus according to claim 1, wherein
the control unit carries out control so that when a plurality of other information processing apparatuses are present, the free viewpoint video at the predetermined viewpoint is generated using video data received from the plurality of other information processing apparatuses.

7. The apparatus according to claim 5, wherein
when a plurality of other information processing apparatuses are present, the control unit controls the number of connections with the other information processing apparatus in accordance with a communication environment of the other information processing apparatus.

8. The apparatus according to claim 1, wherein
the control unit carries out control so that the free viewpoint video at the predetermined viewpoint is generated by receiving some video data for generating the free viewpoint video at the predetermined viewpoint from the other information processing apparatus and receiving the remaining video data from the video delivery apparatus.

9. The apparatus according to claim 1, wherein
the control unit carries out control so as to connect to another information processing apparatus that can be connected to without traversing the video delivery apparatus on the basis of device information of the other information processing apparatus received from the video delivery apparatus.

10. The apparatus according to claim 9, wherein
the device information includes a type of address conversion carried out by a relay apparatus for connecting the information processing apparatus to a network.

11. The apparatus according to claim 1, further comprising:
a determination unit configured to determine whether or not the information processing apparatus has the capability to generate the free viewpoint video,
wherein when the information processing apparatus does not have the capability to generate the free viewpoint video, the control unit carries out control so that free viewpoint video at the predetermined viewpoint generated by the other information processing apparatus is received.

12. The apparatus according to claim 11, wherein
when the information processing apparatus does not have the capability to generate the free viewpoint video, the control unit transmits, to the video delivery apparatus, a search request for another information processing apparatus having the free viewpoint video at the predetermined viewpoint; and
the control unit carries out control so as to communicate with the other information processing apparatus using device information of the other information processing apparatus received from the video delivery apparatus as a response to the search request, and receive the free viewpoint video at the predetermined viewpoint from the other information processing apparatus.

13. The apparatus according to claim 12, wherein
on the basis of the device information of the other information processing apparatus received from the video delivery apparatus as a response to the search request, the control unit carries out control so as to receive the free viewpoint video at the predetermined viewpoint from another information processing apparatus having free viewpoint video with the same composition as the information processing apparatus, another information processing apparatus having viewpoint information that is closest to the viewpoint information of the information processing apparatus, another information processing apparatus having video data for generating the free viewpoint video at the predetermined viewpoint, or another information processing apparatus having reserve processing ability.

14. The apparatus according to claim 13, wherein
the control unit receives different frames of the free viewpoint video or different regions of the free viewpoint video from a plurality of other information processing apparatuses.

15. The apparatus according to claim 1, further comprising:
a designation unit configuration to designate a move destination of the predetermined viewpoint,
wherein the communication unit receives device information of another other information processing apparatus that generates free viewpoint video at a viewpoint included in a predetermined range from a viewpoint selected as a move destination of the predetermined viewpoint through the video delivery apparatus,
the communication unit establishes a connection with the other information processing apparatus using the device information, and
the control unit carries out control so as to receive video data for generating the free viewpoint video on the basis of viewpoint information of the move destination from the other information processing apparatus with which a connection has been established in response to the move destination of the predetermined viewpoint being designated by the designation unit.

16. The apparatus according to claim 15, wherein
the communication unit receives the device information of another information processing apparatus, searched out by the video delivery apparatus, that generates the free viewpoint video at a viewpoint included in the predetermined range from the viewpoint of the move destination designated by the designation unit, and
the communication unit establishes a connection with the other information processing apparatus using the device information.

17. The apparatus according to claim 15, wherein
the designation unit displays a move destination list of viewpoints selected through the video delivery apparatus.

18. The apparatus according to claim 17, further comprising:
a notification unit configured to make a notification that the free viewpoint video can be viewed at the move destination viewpoint,
wherein the display unit sequentially displays the free viewpoint video that can be viewed in response to the move destination of the predetermined viewpoint being designated by the designation unit.

19. The apparatus according to claim 4, wherein
the viewpoint information includes a viewpoint position of the video, a gaze position of a user, a playback time of the video, and a viewing time of the video; and
the device information includes unique information of the information processing apparatus, and an address and port number assigned to the information processing apparatus.

20. A video delivery apparatus which has video data shot from a plurality of directions, and transmits video data for generating free viewpoint video, in which a virtual viewpoint can be changed, to a first information processing apparatus, the video delivery apparatus comprising:
a communication unit configured to transmit, to the first information processing apparatus, video data for generating free viewpoint video at a predetermined viewpoint, on the basis of viewpoint information received from the first information processing apparatus;
a determination unit configured to determine, on the basis of the viewpoint information, whether a second information processing apparatus that generates free viewpoint video at a viewpoint included in a predetermined range from the predetermined viewpoint is present; and
a control unit configured to carry out control so that when the second information processing apparatus is present, the first information processing apparatus communicates with the second information processing apparatus without traversing the video delivery apparatus, and device information for receiving the video data for generating the free viewpoint video at the predetermined viewpoint is transmitted to the first information processing apparatus.

21. The apparatus according to claim 20, wherein
the determination unit determines whether the second information processing apparatus has video data for generating the free viewpoint video at the predetermined viewpoint; and
if the second information processing apparatus has the video data for generating the free viewpoint video at the predetermined viewpoint, the control unit carries out control so that device information of the second information processing apparatus is transmitted to the first information processing apparatus.

22. The apparatus according to claim 20, wherein
the control unit receives a search request for the second information processing apparatus transmitted from the first information processing apparatus; and
the control unit carries out control so that the device information of the second information processing apparatus is transmitted to the first information processing apparatus as a response to the search request.

23. The apparatus according to claim 22, wherein
the search request includes at least viewpoint information pertaining to the predetermined viewpoint and device information of the first information processing apparatus that transmitted the search request; and
the response to the search request includes the device information of the second information processing apparatus.

24. The apparatus according to claim 22, wherein
the search request includes information pertaining to the video data for generating the free viewpoint video at the predetermined viewpoint; and
the response to the search request includes the device information of the second information processing apparatus that has video data for generating the free viewpoint video at the predetermined viewpoint.

25. The apparatus according to claim 23, wherein
when a plurality of the second information processing apparatuses are present, the control unit controls the number of pieces of device information of the second information processing apparatuses transmitted to the first information processing apparatus in accordance with a communication environment of the plurality of second information processing apparatuses.

26. The apparatus according to claim 20, wherein
the determination unit determines whether a second information processing apparatus that can connect to the first information processing apparatus without traversing the video delivery apparatus is present; and
if a second information processing apparatus that can connect to the first information processing apparatus without traversing the video delivery apparatus is present, the control unit carries out control so that the first information processing apparatus and the second information processing apparatus transmit their device information to each other.

27. The apparatus according to claim 26, wherein
the first information processing apparatus can connect to the second information processing apparatus over a network; and
the determination unit determines whether a second information processing apparatus that can connect to the first information processing apparatus without traversing the video delivery apparatus is present on the basis of a type of address conversion carried out by a relay apparatus for connecting the first information processing apparatus and the second information processing apparatus to the network.

28. The apparatus according to claim 27, wherein
the device information includes the type of address conversion carried out by the relay apparatus for connecting the first information processing apparatus and the second information processing apparatus to the network,

29. The apparatus according to claim 20, wherein
wherein the determination unit determines whether the first information processing apparatus has the capability to generate the free viewpoint video on the basis of a search request for the second information processing apparatus received from the first information processing apparatus; and
when the first information processing apparatus has the capability to generate the free viewpoint video, the control unit carries out control to search for a second information processing apparatus having video data for generating the free viewpoint video at the predetermined viewpoint.

30. The apparatus according to claim 20, wherein
the control unit selects a move destination of the predetermined viewpoint in the first information processing apparatus;
the determination unit determines whether a second information processing apparatus that generates free viewpoint video at a viewpoint included in a predetermined range from the viewpoint of the selected move destination is present; and
if the second information processing apparatus is present, the control unit carries out control so that device information of the second information processing apparatus is transmitted to the first information processing apparatus.

31. The apparatus according to claim 30, further comprising:
a receiving unit configured to receive viewpoint information designated as the move destination of the predetermined viewpoint in the first information processing apparatus,
wherein the determination unit determines whether the second information processing apparatuses present on the basis of the viewpoint information of the move destination: and
if the second information processing apparatus is present, the control unit carries out control so that device information of the second information processing apparatus is transmitted to the first information processing apparatus.

32. The apparatus according to claim 20, wherein
the control unit has a data table managing the device information and viewpoint information of the first information processing apparatus and the device information and viewpoint information of the second information processing apparatus; and
the determination unit makes the determination by referring to the data table.

33. The apparatus according to claim 20, wherein
the viewpoint information includes a viewpoint position of the video, a gaze position of a user, a playback time of the video, and a viewing time of the video; and
the device information includes unique information of the information processing apparatus, and an address and port number assigned to the information processing apparatus.

34. A method of controlling an information processing apparatus, the information processing apparatus including a generation unit configured to generate free viewpoint video, in which a virtual viewpoint can be changed, using video data shot from a plurality of directions, and a communication unit configured to receive, from a video delivery apparatus, video data for generating free viewpoint video at a predetermined viewpoint, the method comprising:
carrying out control so that when another information processing apparatus, which generates the free viewpoint video at a viewpoint included in a predetermined range from the predetermined viewpoint, is present, communication is carried out with the other information processing apparatus, and the free viewpoint video at the predetermined viewpoint is generated using video data received from the other information processing apparatus.

35. A method of controlling a video delivery apparatus, the video delivery apparatus having video data shot from a plurality of directions and transmitting video data for generating free viewpoint video, in which a virtual viewpoint can be changed, to a first information processing apparatus, the method comprising:
determining, on the basis of viewpoint information received from the first information processing apparatus, whether a second information processing apparatus that generates free viewpoint video at a viewpoint included in a predetermined range from the predetermined viewpoint is present; and
carrying out control so that when the second information processing apparatus is present, the first information processing apparatus communicates with the second information processing apparatus without traversing the video delivery apparatus, and device information for receiving the video data for generating the free viewpoint video at the predetermined viewpoint is transmitted to the first information processing apparatus.
